(19) United States
(12) Patent Application Publication
(10) Pub. No.: US 2019/0113896 A1
(43) Pub. Date: Apr. 18, 2019

(54) Local and Cloud Based Wireless Intelligent Actuated Devices

(71) Applicants: David R. Hall, Provo, UT (US); Austin Benjamin Carlson, Provo, UT (US); Aaron Myer, Hurricane, UT (US); Emily Brimhall, Alpine, UT (US); Seth Myer, Eagle Mt., UT (US)

(72) Inventors: David R. Hall, Provo, UT (US); Austin Benjamin Carlson, Provo, UT (US); Aaron Myer, Hurricane, UT (US); Emily Brimhall, Alpine, UT (US); Seth Myer, Eagle Mt., UT (US)

(21) Appl. No.: 15/786,933

(22) Filed: Oct. 18, 2017

(51) Int. Cl. G05B 19/042; G06F 11/30

(52) U.S. Cl. CPC G05B 19/042; G05B 2219/2642; G06F 11/3013; G06F 11/3089

(57) ABSTRACT

An intelligent actuation device is described herein. The device includes an actuator, and includes both local and cloud based control facilitated by motors and actuators in each actuation device. Each device further includes a processor with settings stored in memory that direct a controller. Sensors send both local and remote sensor data along with real time weather data to a processor. The processor uses this sensor data to update charts and schedules in memory, then sends commands to the controller based on these updated charts and schedules according to user defined and factory set parameters. Additionally, each actuation device includes a network device and wireless transmitters enabling connection via a mesh network, the network controlled by one or more mobile devices which receive user input.

### FIELD OF THE INVENTION

This invention relates to automation systems, and more specifically to local and cloud based wireless control for intelligent actuated devices within an automation system.

### BACKGROUND

Automation systems are becoming more prevalent in homes, businesses, and manufacturing facilities. Traditionally, automation systems have been proprietary in that expanding or adding new devices to an existing proprietary system may not be possible because new components are not compatible.

There are also many existing systems that have motorized actuators which are not fully automated. Examples of semi-autonomous systems include HVAC systems that are controlled strictly by a thermostat, or a motorized window covering that is opened and closed by a wall switch.

In some cases, it may be desirable to automate a system that has no existing automated components or mechanical drivers to allow the system to be controlled by an automation system. Examples of existing systems that have little to no automation capabilities include traditional manual mechanical window blinds with a hand-operated tilt rod to tilt the slats, or an HVAC system with dampers that may be manually opened and closed.

Actuators are used throughout industry to automate various mechanical components and mechanical systems. In many cases, an actuator is a type of motor that is responsible for moving or controlling a mechanism or system. It is operated by a source of energy, typically electric current, hydraulic fluid pressure, or pneumatic pressure, and converts that energy into motion. An actuator is often a motor that converts energy into torque which then moves or controls a mechanism or a system into which it has been incorporated. It can introduce motion as well as prevent it.

The actuators in most automated systems today are not intelligent. A separate control system typically controls them, wherein the control system sends energy (often in the form of electrical power via an electrical circuit) to the actuator. The actuator is typically a “dumb” device that only operates when it receives power from an external source. This makes it very difficult to add more devices or mechanical components to a system. Typically, the existing system must be expandable and able to accommodate the addition of new components. This requires the existing system to be able to handle these additions by expanding the controller to add new components, and to physically connect these new components by running new electrical circuits. In many cases the existing controller does not have provisions to easily add and expand to include these new components.

Home automation, also known as home monitoring, home control, smart home, or the like, is also becoming more and more prevalent. This increase is due in large part to modern-day advances in software and electronics, coalescence around a number of home automation protocols, and larger numbers of manufacturers willing to build smart devices using these protocols. Home automation may be as simple as automating a few devices in a relatively small home or space, or as complicated as automating an entire residence or building comprising hundreds or even thousands of smart devices. The number and type of smart devices that are available has dramatically increased as more and more manufacturers, including various major technology players, are getting involved in this space. Some of the most popular home automation devices currently utilized include lights, window coverings, thermostats, audio and video systems, door locks, security systems, and the like.

Nevertheless, outfitting a home, business or manufacturing facility with smart devices can be a difficult decision for a home or business owner. Many times, the home or business owner already owns a large number of conventional non-smart devices. Replacing these devices can be expensive and/or wasteful. For example, a home or business owner may have already made a substantial investment in manually-operated window coverings. Replacing the components or devices with automated versions of the same can be prohibitively expensive in addition to requiring significant amounts of labor. Retrofitting can also be problematic in that multiple different designs and sizes may exist, and retrofit solutions may be limited in terms of the designs and sizes they can work with. Retrofitting may also require significant modifications to make the retrofit solution function properly. In certain cases, retrofitting may require removing, cutting or otherwise making major modifications to the various components thereof.

In order to automate an existing system, it may be difficult to extend control wiring to each of the locations, especially in existing buildings or retrofit applications. User control, both at the automated device or component, and from remote locations is needed.

In view of the foregoing, what is needed is a system to automate mechanical components or devices that are currently manually operated, semi-autonomous, or that have proprietary control that does not allow them to be expanded. Ability to wirelessly control the components or devices, both locally (in the building) and from remote locations via the cloud is also needed. Ideally, such a system will enable different types and sizes of existing mechanical components and systems to be automated. Such apparatus and methods will also ideally enable retrofitting these mechanical components while minimizing modifications thereto. Specifically, apparatus and methods are needed to enable mechanical components or devices to provide features and functions compatible with a modular and expandable automation system.

### SUMMARY

The invention has been developed in response to the present state of the art and, in particular, in response to the problems and needs in the art that have not yet been fully solved by currently available apparatus and methods. Accordingly, apparatus and methods in accordance with the invention have been developed to automate actuators. These automated actuators may be attached to an existing mechanical component to allow that component to be controlled by a wirelessly controlled automation system. The automation system of the present invention allows one or more mechanical components to be retrofitted with a wireless intelligent actuator that is connected to all other actuators in the system. Integral network devices in the actuators allow all devices in the network to be managed and controlled by the automation system or by a user. Local control of the actuators may be carried out by any one of several user interface devices, including a wireless mobile device while in the same room or building which has the actuators. Cloud-based control may control the actuators from a cloud-based network based on pre-determined settings and remote input from a user interface device such as a wireless mobile device. The features and advantages of the invention will become more fully apparent from the following description and appended claims, or may be learned by practice of the invention as set forth hereinafter.

In a first embodiment of the invention, a device in accordance with the invention includes: an actuator which is a mechanical actuation device; a processor; a controller that controls the actuator; data stored in memory wherein the memory includes stored settings and calendar data; wherein the stored settings comprise factory preset data; and a performance sensor that senses at least one of electrical performance and mechanical performance of the actuator wherein the performance sensor provides performance data.

The processor is configured to: determine a first set of operating parameters associated with the actuator based on the performance data and at least one of the factory data and first remote data from a remote sensor; determine a control command for operating the actuator based on the first set of operating parameters; determine a second set of operating parameters associated with the actuator based on the performance data and at least one of the factory data and second remote data from the remote sensor; determine that a difference between the second set of operating parameters and the first set of operating parameters exceeds a threshold; modify the control command based on the determined difference; and transmit the modified control command to the controller.

In a second embodiment of the invention, the processor in accordance with the invention is further configured to: store the first set of operating parameters in the memory as baseline data; store the control command in the memory; store the second set of operating parameters in the memory; and store the modified control command in the memory.

In a third embodiment of the invention, the processor in accordance with the invention is further configured to: receive performance data from the performance sensor; receive remote data from the remote sensor, wherein the remote sensor is included in a remote device that is located in a separate location than the actuation device.

In a fourth embodiment of the invention, the performance sensor in accordance with the invention provides performance data, wherein the performance sensor monitors a set of baseline performance parameters associated with the actuator during a first time period, and wherein the performance sensor monitors a set of real time performance parameters associated with the actuator during a second time period.

In a fifth embodiment of the invention, the processor in accordance with the invention is further configured to: store the baseline performance parameters in the memory as performance base data; store the real time performance parameters in the memory as real time data; and determine that a performance difference between the baseline performance parameters and the real time data exceeds a threshold, wherein the determined difference comprises the performance difference.

In a sixth embodiment of the invention, the processor in accordance with the invention is further configured to identify an anomaly in the expected mechanical or electrical behavior of the actuator based on the determined performance difference.

In a seventh embodiment of the invention, the processor in accordance with the invention is further configured to transmit a trouble signal to another device; wherein the trouble signal comprises data describing one or more defining characteristics of the anomaly.

In an eighth embodiment of the invention, the modified control command compensates for the anomaly, wherein the modified control command causes the controller to send at least one modified signal to the actuator that causes the actuator to at least one of speed up, slow down, or stop in order to compensate for the anomaly.

In a ninth embodiment of the invention, the performance sensor comprises at least one of an electrical sensor; mechanical sensor; transducer; electromagnetic; electrochemical; electric current; electric potential; magnetic; radio; accelerometer; pressure; electro-acoustic; electro-optical; photoelectric; electrostatic; thermoelectric; radio-acoustic; electrical resistance; mechanical resistance; position resolver, optical encoder, capacitive encoder, Hall-effect device, incremental encoder, absolute encoder, absolute transducer of position, capacitive encoder, PIR, pyroelectric, magnetic field, vibration, motor speed, frequency, rotation, torque, ultrasonic, temperature, velocity; position; angle; displacement; or combinations thereof.

In a tenth embodiment of the invention, the actuation device in accordance with the invention also includes a network device; wherein the network device communicates to a plurality of actuation devices within an actuation system.

In an eleventh embodiment of the invention, the network device in accordance with the invention also includes a wireless transmitter and wireless transceiver; wherein the network device has a connection to each network device of the one or more actuated devices; wherein the connection comprises a wired or wireless interface; and wherein the wireless interface comprises Bluetooth, WIFI, mesh network or similar wireless protocol.

In a twelfth embodiment of the invention, the processor in accordance with the invention is also configured to receive user data from one or more user input devices; wherein the one or more user input devices comprises a user interface for receiving the user input from a user.

In a thirteenth embodiment of the invention, the user input device in accordance with the inventio is a mobile device capable of wirelessly transmitting and receiving a signal; wherein the mobile device has a connection to the actuation device; wherein the mobile device comprises a cell phone, satellite phone, smartphone, personal digital assistant, tablet computer, laptop computer, remote control device, mobile transmitter, a mobile internet device or a combination of one or more of the same.

In a fourteenth embodiment of the invention, the performance sensor in accordance with the invention is at or adjacent to the actuator; wherein the performance sensor converts sensor data to an electrical signal; and wherein the performance sensors are of one of the following types: electromagnetic; electrochemical; electric current; electric potential; magnetic; radio; air flow; accelerometers; pressure; electro-acoustic; electro-optical; photoelectric; electrostatic; thermoelectric; radio-acoustic; environmental; moisture; humidity; fluid velocity; position; angle; displacement; or combinations thereof.

In a fifteenth embodiment of the invention, the remote data in accordance with the invention is transmitted from a remote system located in a separate part of a room, building, or outside of a building, wherein the remote system comprises at least one of a weather station, security system, wireless remote sensor device, fire alarm system, HVAC system, building control system, manufacturing control system, monitoring system; control system, or combinations thereof, wherein the remote sensors convert sensor data to an electrical signal, and wherein the remote sensors comprise at least one of: electromagnetic, electrochemical, electric current, electric potential, magnetic; radio, air flow, accelerometers, pressure, electro-acoustic, electro-optical, photoelectric; electrostatic, thermoelectric, radio-acoustic, environmental, moisture, humidity, fluid velocity, position, angle, displacement, or combinations thereof.

In a sixteenth embodiment of the invention, the processor in accordance with the invention is further configured to communicate with a cloud based network, and mirror the stored settings and calendar data with the cloud based network by sending and receiving system data to and from the cloud-based network. The system data includes all data in the memory.

In a seventeenth embodiment of the invention, the remote data in accordance with the invention includes weather data, security system data and sensor data from remote systems. The remote data from the remote sensors and remote systems is relayed to the actuation device via the cloud-based network or wireless network associated with and connected to the actuator network device. The processor is also configured to: determine a remote command based on at least one of the remote data, the stored settings, calendar data, and as directed by predefined user settings, or combinations thereof; and transmit the remote command to the controller.

In an eighteenth embodiment of the invention, the actuation device in accordance with the invention includes one or more of electric motors, gearboxes and one or more mechanical means of incrementally opening, closing, tilting, turning, twisting, sliding, pushing, pulling, and rotating one or more components of the actuated device.

In a nineteenth embodiment of the invention, the actuation device in accordance with the invention also includes one or more batteries and one or more solar photovoltaic panels.

The apparatus and methods disclosed herein may be embodied in other specific forms without departing from their spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1A is a perspective view showing one embodiment of an actuator in accordance with the invention;

FIG. 1B is a top view showing various internal components of an actuator in accordance with the invention;

FIG. 2 is an illustration showing one embodiment of three actuators and a mobile device in accordance with the invention;

FIG. 3 is an illustration showing one embodiment of three actuators, a mobile device, the cloud, a network router and a cell phone tower as illustrated in accordance with the invention;

FIG. 4 is an illustration showing one embodiment of three actuators, the cloud, a weather station, a security system and a network router as illustrated in accordance with the invention;

FIG. 5 is an illustration showing an embodiment of four actuators in accordance with the invention;

FIG. 6 is an illustration showing one embodiment of two actuators, the cloud, two conveyor belts, one set of vertical blinds and a mobile device in accordance with the invention;

FIG. 7 shows a graphical user interface for setting up and automating actuators in different rooms or spaces;

FIG. 8 shows a graphical user interface for creating a new room and establishing a default closed and open position for actuators associated with the new room;

FIG. 9 shows a graphical user interface for monitoring a battery charge level for actuators in a room;

FIG. 10 shows a graphical user interface for displaying a schedule associated with an actuator;

FIG. 11 shows a graphical user interface for scheduling an event associated with an actuator;

FIG. 12 shows a graphical user interface for setting up and changing settings associated with an actuator;

FIG. 13 shows a graphical user interface for adjusting light settings associated with an actuator;

FIG. 14 shows a graphical user interface for adjusting room settings for actuators in a room;

FIG. 15 shows a graphical user interface for establishing settings associated with an application;

FIG. 16 shows a graphical user interface for adding or editing accessories associated with a room or actuator;

FIG. 17 is a high-level system view showing various components internal to and external to an actuation device in accordance with the invention;

FIG. 18 is a high-level view of the system of FIG. 17, particularly showing possible physical locations of various components described in association with FIG. 17;

FIG. 19 is a high-level view showing various modules providing different functionality in the system of FIG. 17;

FIG. 20 is a perspective view of one embodiment of a specialized wall switch in accordance with the invention;

FIG. 21 is a high-level view showing various components that may be controlled by the specialized wall switch discussed in association with FIG. 20;

FIG. 22 shows one embodiment of a touchscreen providing functionality similar to the specialized wall switch illustrated in FIG. 20;

FIG. 23 shows another embodiment of a touchscreen providing functionality similar to the specialized wall switch illustrated in FIG. 20.

### DETAILED DESCRIPTION

It will be readily understood that the components of the present invention, as generally described and illustrated in the Figures herein, may be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

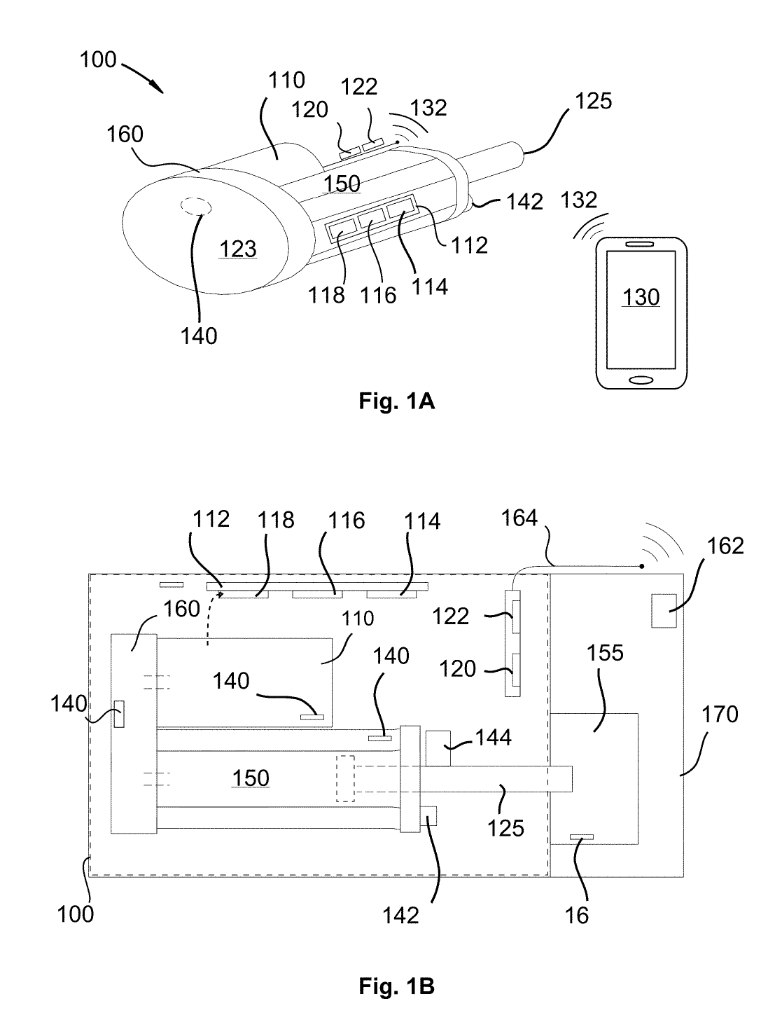

Referring to FIG. 1A, one example of an actuation device 100 is shown. In this example, a motorized actuator 123 is illustrated along with components of an actuation device 100 according to an example embodiment of the invention. In the illustrated embodiment, the actuation device 100 includes

Mobile device 130, as shown in FIG. 1, transmits and receives via wireless signal 132 from the wireless transmitter 120 and wireless receiver 122, allowing wireless control by a user of the system. The preferred embodiment is Bluetooth communication which is present in most mobile devices such as cell phones, laptops or mobile computer tablets. The first time a user sets up the system, the processor will identify the user as a master user. The system will be pre-set from the factory with factory settings defining the general operation of the actuator. Any changes to the factory settings may be saved by the master user, including permission settings for other users. The master user may allow other users to access all or only selected control of specific system settings or controls as defined by the master user.

Processor 114 receives inputs from performance sensor 142, mechanical sensor 140, and from other sensors at other locations. The factory preset settings along with user settings direct the operation of the system. These settings are stored in the memory for data storage, the memory module 116 being mounted to the same circuit board as the processor 114 as part of the main control module 112. As inputs are received from sensors, weather data, and other real-time data, the processor 114 consults the settings in memory to determine what action (e.g., control command), if any, to take. Calendars and schedules are also consulted prior to sending commands to the controller. For example, the processor may determine a control command based on sensor data, stored settings, remote data from a cloud-based network, user input, and/or system data (i.e., at least three of the foregoing, at least four of the foregoing, and so forth). Once the processor has determined that an action should be taken, appropriate command signals are sent to the controller 118 which then activates motor 110 which in turn operates the piston 125 as required for this example embodiment.

It is appreciated that the processor may determine the appropriate control command based on a combination of factors, such as sensor data, stored settings, remote data received from a cloud-based network, system data, input data, and the like. In some cases, the processor compares the user input data with stored system settings and sensor data and determines a control command that is similar to, but modified as a result of the comparison, to balance the user preferences with the stored settings, any remote data, and sensor data. In one example, the determined control command is different (e.g., tempered or exaggerated version) than a control command that would be generated based on any of the factors individually (e.g., the user input data alone, the sensor data alone, the stored settings alone, etc.). In other words, the determination step weighs together multiple factors (e.g., at least three, at least four, etc.) to determine the appropriate control command. This usage of multiple data sources (e.g., sensors, stored settings, remote servers, system data, environmental factors, etc.) to determine a control command improves efficiency, consistency, and/or interoperability of platforms (using cloud control, for example), thus facilitating/enabling smarter control of the actuation device.

In addition, the determination of control commands is also based on a user determined hierarchy of importance in determining which commands are priority when there are multiple actions based on more than one data source. For example, there may be factory settings that determine when the actuation device may be opened based on a daily schedule. However, when setting up the system, a user may determine that the actuators should be closed in the morning for one hour. This new user setting may override a factory pre-set “open” command to assure that the actuators are closed at this time. Another example is when the temperature outside exceeds a user determined minimum, there may be a command sent from the controller to close certain actuators in order to reduce the heat by closing dampers. This command may override the normal schedule of operation for that day. This override would also be pre-configured by the user to allow the controller to make this determination and carry out the modification of the operation based on sensor data when necessary.

Network device 122 connects each actuation device to other actuation devices in the system. The network device 122 also connects the system to a building local network with connection to the internet for access to a cloud network. One or more wireless transmitters 120 and receivers 122 may be included. One wireless transmitter 120 and receiver 122 may connect to the Bluetooth mesh, and a second wireless transmitter 120 and receiver 122 may connect to the building WIFI system for connection to the cloud and internet.

In order to determine the baseline operating parameters, the relationship between a motor's electrical characteristics and mechanical performance may be calculated.

For example, an ideal brushed DC motor may be approximated as a circuit with a resistor, and voltage back-emf source. The resistor models the intrinsic resistance of the motor windings. The back-emf models the voltage generated by the moving electric current in the magnetic field.
The generator produces a back EMF proportional to speed of the motor:

Vemf=ki*ω

Where: ki=a constant; ω=the motor speed in rad/s
Ideally at stall speed there is no back emf, and at the no-load speed the back emf is equal to the driving source voltage.
The current flowing through the motor may then be calculated as:

The current flowing through the motor may then be calculated as:

I=(VS−Vemf)/R=(VS−ki*ω)/R

Where: VS=source voltage; R=motor electrical resistance
The current flowing through the motor may be calculated as described above, or may also be detected using current sensors.

For the mechanical calculations, the torque generated by the motor is proportional to the amount of current flowing through the motor:

τ=kt*I

Where: kt=a constant; τ=torque
Using the above electrical model, it may be verified that at the stall speed the motor has the maximum current flowing through it, and thus the maximum torque. Also, at the no load speed the motor has no torque and no current flowing through it. The torque may also be detected by a torque sensor.

Power can then be calculated one of two ways:

Electrical Power: Pe=VS*I

Mechanical Power: Pm=τ*ω

In order to determine baseline performance of the motor, at least the voltage and stall current may be detected and recorded. This provides the no-load speed and stall torque so that the processor may calculate the mechanical performance of the motor.

There are typically at least three sources of data relating to motor performance:

1. Factory voltage, current, torque and power ratings under specified loads or conditions.
2. Calculated voltage, current, torque and power.
3. Detected voltage, resistance, magnetic force, current, torque and power from sensors.
All three of these sources of data are used to determine the baseline data for the operating parameters. Performance sensors continually monitor the motor performance to detect any anomalies in the expected behavior of the motor in the system. As changes are detected, the processor may make adjustments in order to compensate for these anomalies.

On system start-up, the sensors detect current, voltage, torque, RPM and other applicable conditions relating to the system the motor is operating in. This detected data is recorded in memory as part of the baseline data. Subsequent sensor data collected after start-up will be compared to this baseline data to determine any departures from the expected system behavior.

For example, a motor in a system may have baseline data that includes an in-rush current of 10 amps for 2 seconds, then once started the motor settles in to a running current of 0.5 amps under normal conditions. If the sensors detect changes in the in-rush current that exceed 10 amps, the processor may make adjustments to the system in order to reduce the load at start-up by decreasing the power delivered to the motor. The motor current may also be ramped up gradually at start-up by use of a soft start, variable frequency drive or other motor control system in order to compensate for the anomaly.

Changes in other parts of the system may also influence motor behavior. For example, if an actuator is rotating a mechanical arm that becomes jammed or blocked—this blockage may be detected by sensors at the motor indicating increased load and torque during an operation that normally does not require that high of power. In this case, rather than continuing the operation, the processor may send a “stop” command to the motor in order to prevent damage to the motor or other parts of the system (bending or breaking the arm that is jammed).

In both of these examples, the system may also send an alert to the user indicating that there is a variance in operation of the system, and what that variance is. The alert may be in the form of a “trouble” signal indicating that the motor is still functioning but may be operating in a modified fashion (slower start-up for example). In other cases, the system may alert the user that some action may be needed in order to repair or fix a problem (the arm is jammed). The processor may also send a “stop” command to the motor controller when certain serious conditions exist based on the sensor data.

Other sensors (temperature for example), may provide more information about the motor. In some cases, an increased temperature at the motor may indicate an abnormality in either the system or the motor itself.

It is appreciated that the performance data and operating metrics may be gathered as the motor functions. A set of operating parameters, corresponding to the performance data and operating metrics may be compared with a previous set of operating parameters (e.g., baseline parameters, or some previous operating parameters). If it is determined that the difference in operating parameters exceeds a threshold (there is a jam or blockage, for example), then the processor may determine and adjusted command to account for the difference in operating parameters. In some embodiments, the adjusted command is generated by modifying the typical command that is sent (by adjusting/throttling the current, timing, or other parameters associated with the motor operation, for example). In other examples, the adjusted command is generated by replacing the typical command (like move to fully open or fully closed, for example) with a stop command (to stop all movement and alert a user so as to avoid breakage due to a jam or blockage for example).

It is appreciated that this adjusted and modified control may be used to aid synchronizing operation among multiple actuators, to account for increased friction due to wear, and/or to correct for severe problems, such as jams and blockages. Using the performance data (e.g., the current, voltage, and power data discussed above) and evaluating the operating parameters (which may provide a broader picture of effectiveness in operation, for example) of the motor/actuator with respect to previous operating parameters may enable enhance error detection and correction, so that minor errors our issues may be discovered and accounted for and bigger issues can be addressed or corrected without system breakage or a compromised user experience.

Referring to FIG. 1B, a top view is shown which includes various internal components of an actuation device 100 and an attached mechanical component being controlled by the actuation device 100. In this embodiment, the mechanical component is a valve 155. In most cases, remote sensors are located in a separate room or building or even outside of the building. However, in this embodiment, there is a remote sensor 162 monitoring the environment in an area outside of the actuation device 100 enclosure. Remote sensor 162 is in the valve enclosure 170, and remote mechanical sensor 16 inside the valve body monitors mechanical functions associated with the valve 155. Piston 125 extends from the actuation device 100 to the valve 155 providing the mechanical force required to open and close the valve 155.

Mechanical sensors 140 are located inside the motor 110, the actuator cylinder 150, and the gearbox 160. Performance sensor 142 is mounted on the actuator, and optical sensor 144 is mounted directly adjacent to the piston shaft 125. The main control module 112 includes the processor 112, the memory module 116 and the controller 118. Signals from the wireless transmitter 120 and wireless receiver 122 are broadcast via antenna 164.

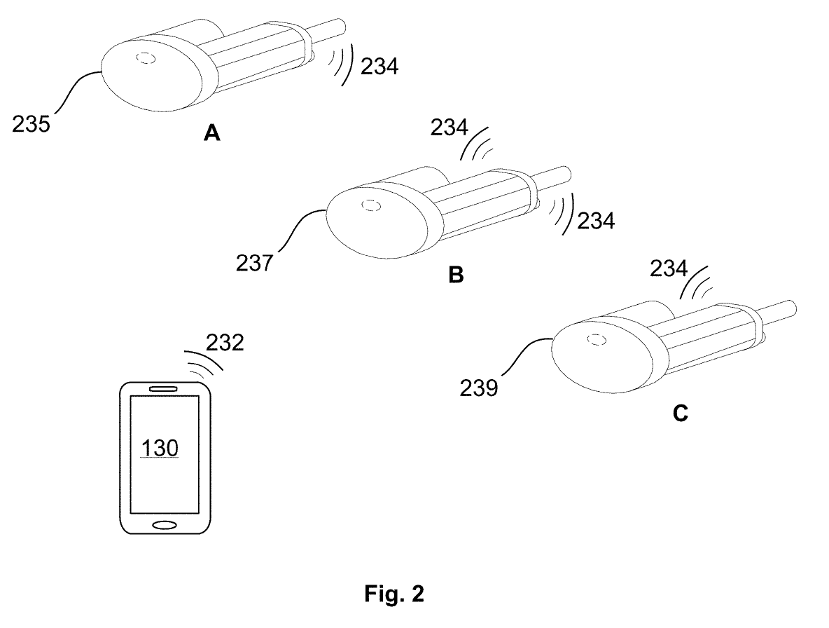

Referring to FIG. 2, an example of three actuators and a mobile device is illustrated. Actuator 235 transmits and receives Bluetooth mesh wireless signal 234 from actuator 237 and actuator 239 which also each transmit and receive Bluetooth mesh wireless signal 234. If actuator 237 becomes inoperable, actuator 235 and actuator 239 will remain in communication with each other. Mobile device 130 transmits and receives via wireless signal 132, which communicates via Bluetooth to one or more of the actuator. Mobile device 130 only requires a connection to one of the network devices in order to be connected to the system since all of the network devices in the system are connected via the Bluetooth mesh.

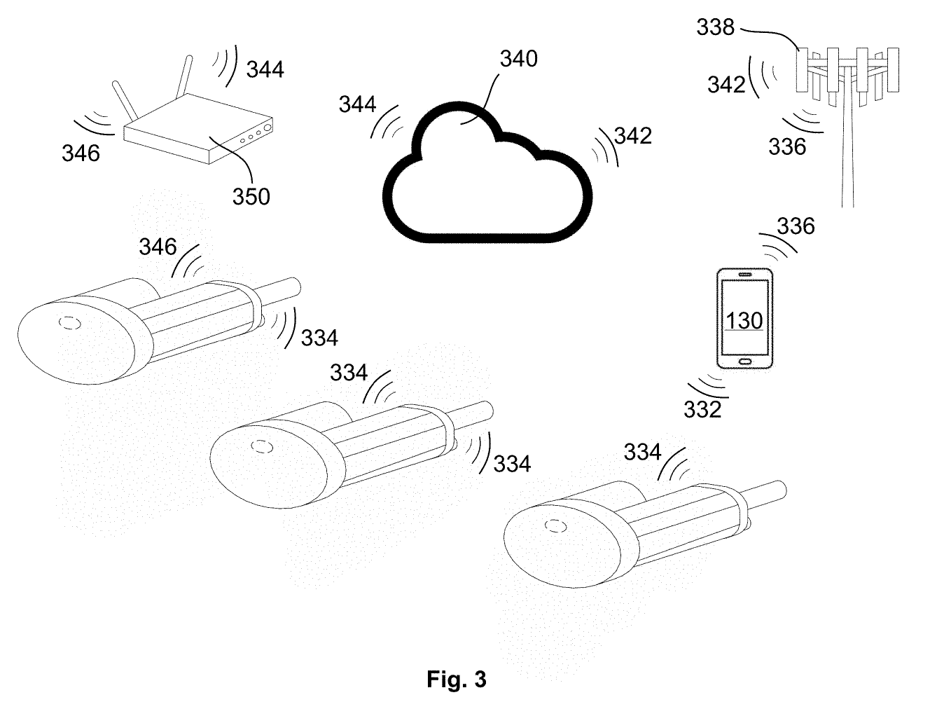

Referring to FIG. 3, an example of three actuators, a mobile device, the cloud, a network router and a cell phone tower is illustrated. The three actuators illustrated are connected via Bluetooth mesh wireless signal 334. Mobile device 130 transmits and receives via wireless signal 332, which communicates via Bluetooth to one or more of the actuators. The actuators are also connected to the cloud via WIFI signal 346 to local building network router 350 which is connected via wireless internet signal 344 to the cloud-based network 340. Cloud based network 340 also connects to cellular network 338 which connects via cell signal 336 to mobile device 130. This connection via the cellular network 338 allows the mobile device to connect to the system from anywhere there is cell service. The mobile device 130 may also connect to the cloud based network 340 via WIFI in remote locations. Connection to the cloud via other access points include mobile devices equipped with satellite radios that are connected to the cloud via satellite signal transmission. WIFI signal 346 may also provide wireless access to the mobile device 130. Network cloud signal 342, internet signal 344, and WIFI signal 346 are represented as wireless interfaces, however these may also be wired connections.

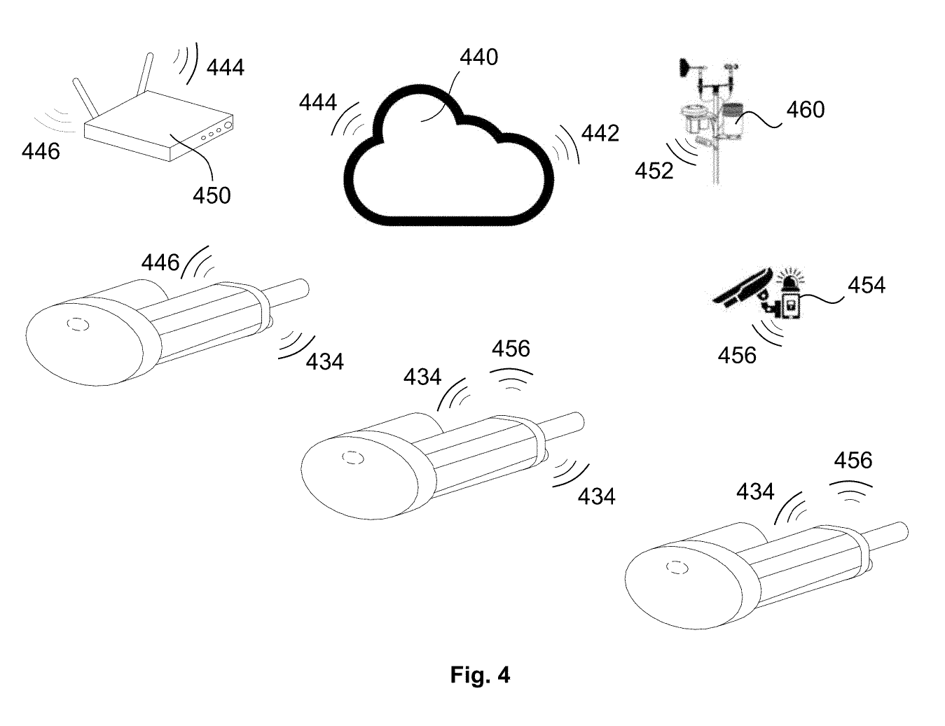

Referring to FIG. 4, an example of three actuators, the cloud, a weather station, a security system and a network router is illustrated. In this example embodiment, the three actuators illustrated are connected via Bluetooth mesh wireless signal 434. Security system signal 456 connects the actuators to security system 454 which communicates security system data to the system. This data is used by the processor to determine what actions are to be taken in response to motion sensors, cameras or other security devices. The security system 454 may alert the system to open and close actuators to close gates, lock doors or activate other security related actions based on user defined or factory settings. Weather station 460 may relay weather related data to the system via weather signal 452 to the cloud-based network 440. This data may be received via network cloud signal 442 to the cloud based network 440, then relayed via internet signal 444 to the building network router 450 which connects to the system via WIFI signal 446. Security system signal 456, weather signal 452, and network cloud signal 442 are represented as wireless interfaces, however these may also be wired connections.

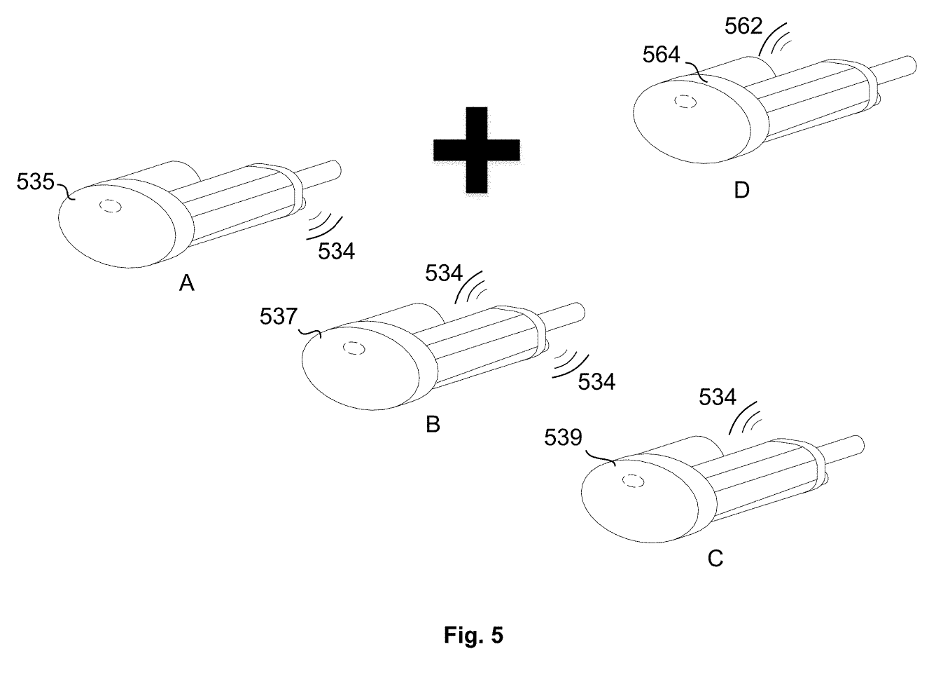

Referring to FIG. 5, an example of four actuators is illustrated. Actuator 535 transmits and receives Bluetooth mesh wireless signal 534 from actuator 537 and actuator 539, which also each transmit and receive Bluetooth mesh wireless signal 534. Actuator 564 is a new actuator being added to the system. During set-up, actuator 564 transmits an origination Bluetooth signal 562 that alerts the Bluetooth mesh that a new node is to ready to be connected to the system. The system automatically accepts and integrates the new actuator 564 into the mesh network. All configuration and operational settings for the new actuator 564 are forwarded to actuator 564 from the system via the mesh network, and actuator 564 operates according to these settings.

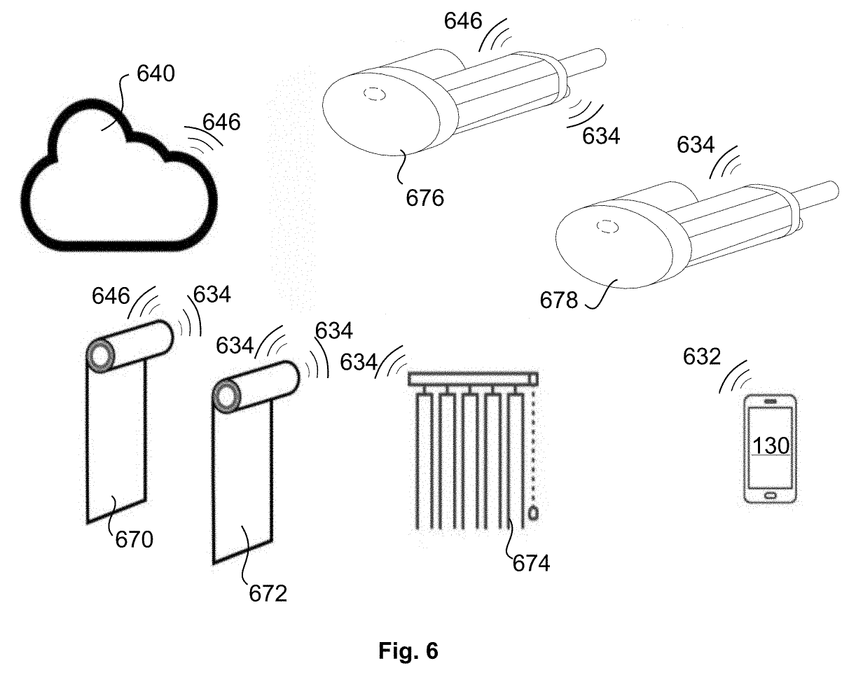

Referring to FIG. 6, an example of two actuators, the cloud, two conveyor belts, one set of vertical blinds and a mobile device is illustrated. Mobile device 130 transmits and receives via wireless signal 632, which communicates via Bluetooth to one or more of the actuators. Actuators included in the system are connected via Bluetooth mesh wireless signal 634. First actuator 676 and second actuator 678 are connected to the mesh via Bluetooth mesh wireless signal 634. First actuator 676 connects to the cloud-based network 640 via WIFI signal 646. First conveyor belt 670 and second conveyor belt 672 are also connected to the system via Bluetooth mesh wireless signal 634. Conveyor belt 670 also shows a WIFI signal 646 to the cloud based network 640. Vertical blinds 674 connects to the mesh via Bluetooth mesh wireless signal 634. All shown actuators may be controlled by user input at mobile device 130 via wireless signal 632. All actuator types shown in this embodiment are art of the same actuator system that are controlled together via a combined wireless mesh. They may be individually controlled by mobile device 130 or the cloud-based network 640, or may be controlled globally (meaning all actuators in the system) by the same. One command by a user at the mobile device 130 may open all actuators in the system. Likewise, one calendar setting stored in memory of the cloud based network 640 may send a command to all of the actuators in the system to open as required by the calendar setting. This calendar setting may be pre-programmed as a factory preset. The factory preset times may be modified by a user to reflect preferences of the user that differ from the presets. Once the revised presets have been saved by a user, they may be stored in both the cloud-based network 640 and in the memory of each actuator within the actuator system.

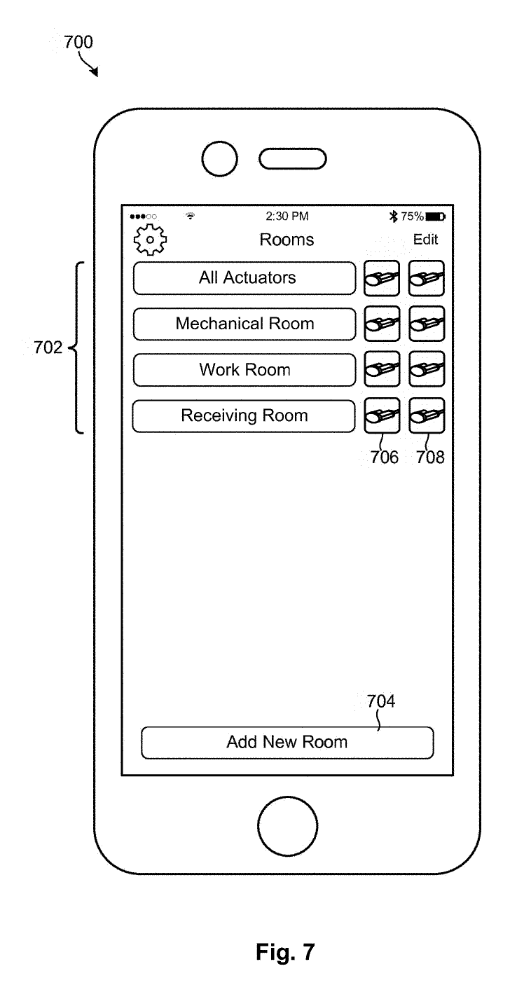

In certain embodiments, the application is configured to execute on a user's mobile device, such as a tablet or smart phone. FIGS. 7 through 16 show various exemplary graphical user interface (GUI) pages associated with an application configured to execute on a mobile device. Nevertheless, in other embodiments, the application may be configured to execute on a desktop computer, workstation, laptop, or other suitable computing device.

Referring to FIG. 7, one embodiment of a GUI page 700 for setting up actuation devices 100 in various rooms of a home or business is illustrated. When automating a home or business, multiple actuation devices 100 may be retrofitted with a mechanical component in accordance with the invention. In many cases, individual rooms in the home or business may contain multiple actuation devices 100. In certain cases, a user may want all actuation devices 100 in a home or business, or all actuation device 100 in a particular room of a home or business, to be programmed in the same or a similar manner. Similarly, when using manual controls to operate the actuation device 100, the user may wish to operate all actuation device 100 in a home or business, or in a room of the home or business, as a group as opposed to individually.

FIG. 7 shows one embodiment of a Rooms page 700 that enables a user to establish rooms in a home or business, as well as operate all actuation device 100 in the home or business, or in a room of the home or business, as a group. In the illustrated embodiment, buttons 702 are provided to represent the home or business, as well as each room that has been established in the home or business. Selecting a button 702 may enable a user to configure the home or business, or a room in the home or business, such as by adding actuation device 100 to the home, business, or particular room. For example, selecting the “All Actuators” button 702 may allow the user to configure all actuation devices 100 associated with the home or business. Similarly, selecting the “Mechanical Room” button 702 may allow the user to configure actuation device 100 in the mechanical room. An “Add New Room” button 704 may enable a user to add a new room to the list 702.

As shown, various manual controls are provided on the “Rooms” page 700. For example, an open button 706 may cause all blinds in a home or business, or a particular room in the home or business, to open. Similarly, a close button 708 may cause all blinds in the home or business, or the particular room in the home or business, to close. The buttons 706, 708 may be configured to operate in different ways. For example, pressing and holding the button 706, 708 may cause the slats of the actuation device 100 to tilt until the buttons 706, 708 are released. This would allow various intermediate tilt positions or angles to be achieved. By contrast, single or double clicking a button 706, 708 may cause the slats of the actuation device 100 to open or close completely without having to hold down the corresponding buttons 706, 708. This is simply an example of possible operation and is not intended to be limiting.

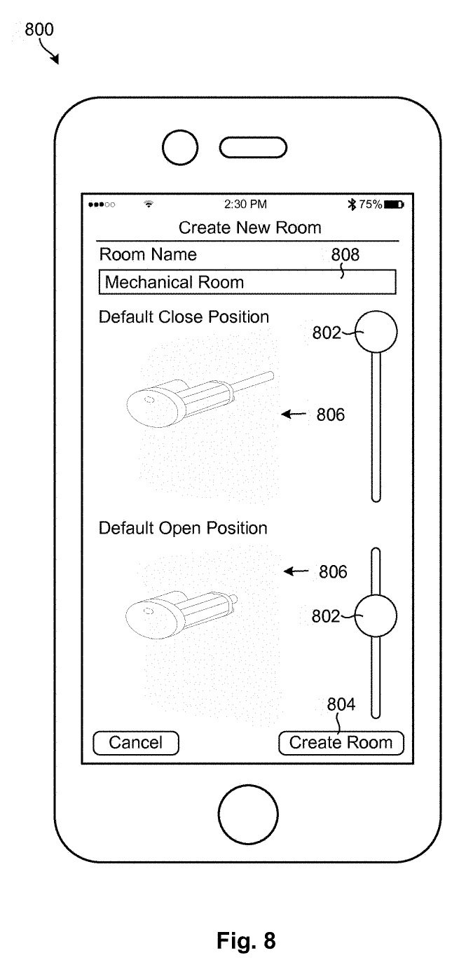

Referring to FIG. 8, one embodiment of a Create New Room page 800 is illustrated. Such a page 800 may be displayed upon selecting the Add New Room button 704 discussed in association with FIG. 7. As shown, the “Create New Room” page 800 enables a user to designate a room name (e.g., “Mechanical Room”) in a field 808, as well as designate a default open and closed position for actuation device 100 associated with the room. As shown in FIG. 8, slider buttons 802 are provided to enable the user to establish the open and closed positions for the actuation devices 100. In certain embodiments, actuator depictions 806 adjacent to the buttons 802 are animated in response to movement of the slider buttons 802. That is, as the slider buttons 802 are moved up or down, the actuator depictions 806 appear to open and/or close to reflect the actual position of the actuated component. Once a room is named and the default open and closed positions are established, a “Create Room” button 804 may be selected to create the room. This will, in turn, cause the room to be added to the list 702 illustrated in FIG. 7.

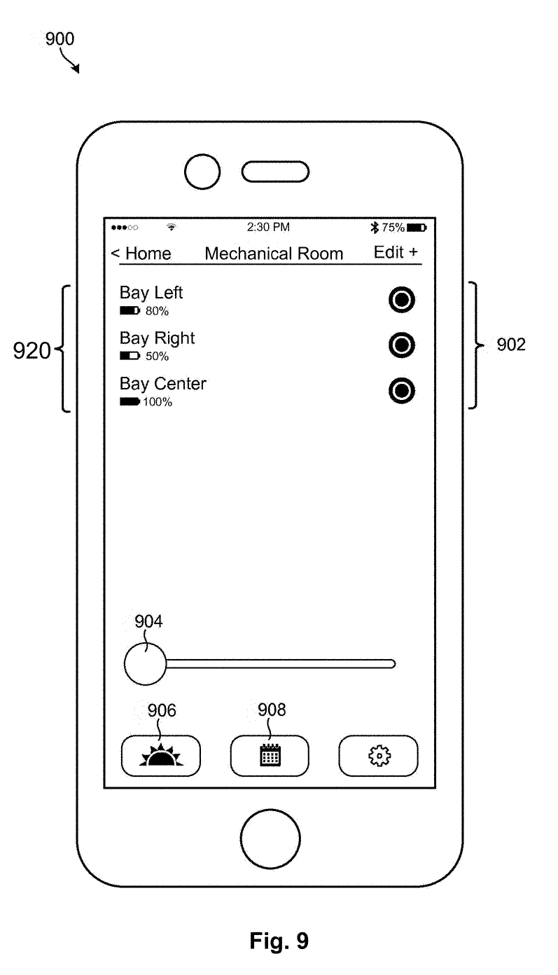

Referring to FIG. 9, one embodiment of a page 900 for configuring a room is illustrated. Such a page, for example, may be displayed in response to selecting one of the buttons 702 illustrated in FIG. 7. This page 900 may enable a user to add, delete, modify, or monitor actuation device 100 associated with a particular room or space. In the illustrated example, the room Mechanical Room includes three locations within a room 920, namely “Bay Left, Bay Right,” and “Bay Center.” Indicators are provided to show a battery charge level associated with each of the actuation devices 100. As further shown, each of the actuation device 100 includes a button/indicator 902. In certain embodiments, the outer ring may indicate whether the actuation device 100 is online and connected whereas the inner circle may enable a user to select the actuation device 100 so that it can be controlled and/or configured. For example, upon selecting one or more actuation device 100 in the list, a slider button 904 may enable the actuation device 100 to be manually opened or closed by moving the slider button 904.

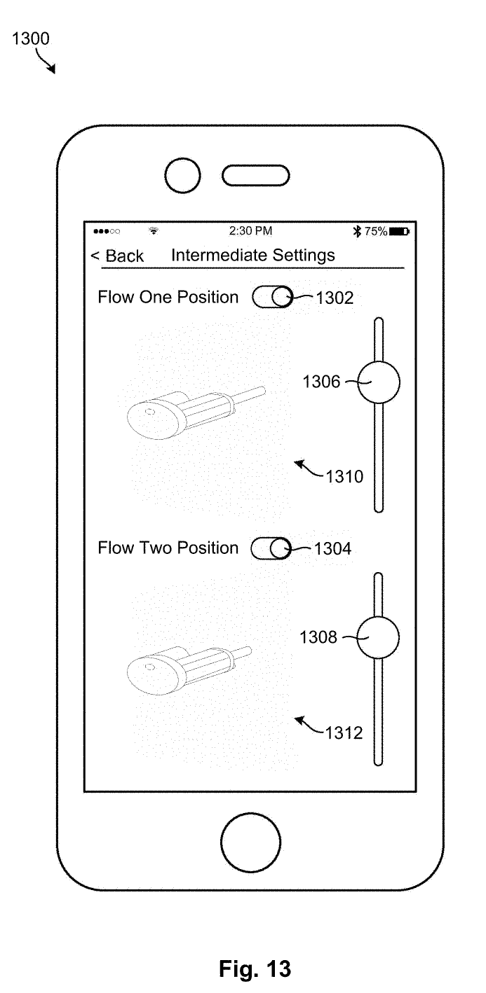

Various different buttons for configuring the actuation device 100 are shown at the bottom of the page 900. For example, a button 906 may be selected to configure an actuation device 100 or a group of actuation device 100 to operate in accordance with sensed lighting conditions. For example, a user may want an actuation device 100 or a group of actuation device 100 to open at sunrise and/or close at sunset. Selecting the button 906 may open up a page that enables the user to configure the actuation device 100 in such a manner. One embodiment of such a page is illustrated in FIG. 13.

Similarly, a button 908 may be selected to configure an actuation device 100 or a group of actuation devices 100 to operate in accordance with a defined schedule. For example, a user may want an actuation device 100 or a group of actuation device 100 to open and/or close at designated times. In certain embodiments, different open/close times may be established for different days of the week. Selecting the button 908 may open up a page that enables the user to configure the actuation device 100 to operate in accordance with the established schedule. One embodiment of such a page is illustrated in FIG. 30.

Referring to FIG. 30, one embodiment of a page 1000 for establishing a schedule for an actuation device 100 or a group of actuation device 100 is illustrated. In the illustrated embodiment, a time line 1010 is provided for each day of the week. A user may establish different types of events 1014 on the time line 1010. For example, a user may wish to establish an open event 1014 at a designated time and a close event 1014 at a different designated time. For example, as shown in the illustrated embodiment, an open event 1014 is established at 7:15 AM and a close event 1014 is established at 9:30 AM. In certain embodiments, events 1014 may also be established for states other than open/close states. For example, a user may want an actuation device 100 or a group of 100 to be fifty percent (or some other percentage) open at a designed time. In the illustrated embodiment, a partial open event 1014 is established at 8:30 AM.

In certain embodiments, each time line 1010 may have a status bar 1012 associated therewith. This status bar 1012 may show a status of an actuation device 100 or a group of actuation device 100 during different time periods. For example, the color white on the status bar 1102 may indicate that an actuation device 100 or group of actuation device 100 is open over the indicated time period. Similarly, the color black may indicate that the actuation device 100 or group of actuation devices 100 are closed during the indicated time period. Shades of grey may indicate a state of partial openness, the degree of which may be indicated by the shade.

In certain embodiments, a gradual change in color along the status bar 1012 may indicate that an actuation device 100 or group of actuation devices 100 are gradually opening or closing over the indicated time period. For example, as can be observed in FIG. 30, an actuation device 100 or group of actuation device 100 is partially open until 7:15 AM, at which time they completely open. The actuation device 100 or group of actuation devices 100 then gradually close until they reach a designated state of partial openness at 8:15 AM. The actuation device 100 or group of actuation devices 100 gradually continue to close until they are completely closed at or around 9:30 AM and thereafter. In certain embodiments, an event 1014 may indicate when an operation (open, close, etc.) begins. In other embodiments, an event 1014 may indicate when an operation ends. In yet other embodiments, an operation may be centered with respect to an event 1014 such that the operation may begin before the designated event time and end after the designated event time.

In certain embodiments, creating an event 1014 may be as easy as selecting an area on a time line 1010 where an event 1014 is desired to be placed. A page or menu may appear that allows the user to establish details or settings for the event 1014. Similarly, selecting or manipulating an already existing event 1014 may allow details or settings associated with the event 1014 to be changed. In certain embodiments, a time or day associated with an event 1014 may be changed by simply selecting and dragging the event 1014 to a desired time or day on the page 1000. Other techniques for creating, modifying, or deleting events 1014 may be used and are within the scope of the invention.

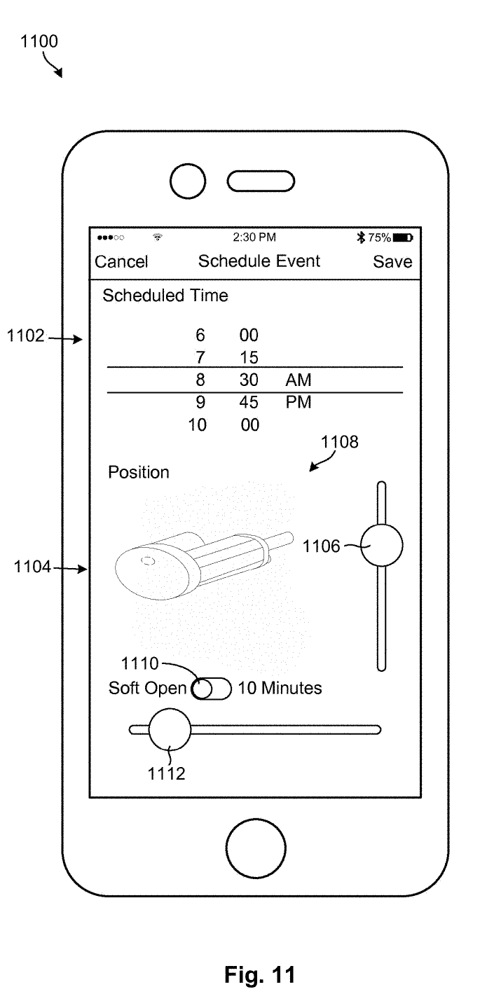

Referring to FIG. 11, one embodiment of a page 1100 for creating or modifying an event 1014 is illustrated. In this embodiment, a time-selection feature 1102 enables a user to specify a desired time for an event 1014. Similarly, a position-selection feature 1104 enables a user to specify a desired position for an actuation device 100 or group of actuation devices 100 for an event 1014. This position-selection feature 310 may, in certain embodiments, enable a user to select an open state, closed state, or an intermediate state associated with the event 1014. In certain embodiments, a slider button 1106 is provided to enable the user to designate the position of the actuation device 100 or group of actuation devices 100. An actuator graphic 1108 adjacent to the button 1106 may be animated in response to movement of the slider button 1106 to show a position of the actuation device 100 or group of actuation devices 100.

In certain embodiments, the page 1100 may also enable a user to designate how fast an actuation device 100 or group of actuation devices 100 open or close in association with a particular event 1014. For example, a user may want an actuation device 100 or group of actuation devices 100 to open or close over a designated period of time (e.g., 10 minutes, 30 minutes, an hour, etc.) instead of opening or closing in an abrupt manner. This may provide a more aesthetically pleasing way to operate the actuation device 100 and/or enable actuation device 100 to operate gradually to mirror or reflect the gradual movement of the sun. This may also maximize the amount of sunlight that is allowed to enter a room while at the same time preventing direct sunlight and associated damage on furniture, rugs, or other objects, even as the angle of incidence of the sun changes throughout the day. In certain embodiments, a button 1110 (e.g., a soft close button 1110) may be provided to enable this feature. Similarly, in certain embodiments, a slider button 1112 (or other feature such as an input field) may be provided to enable a user to establish how long it takes for an actuation device 100 or group of actuation devices 100 to transition between states.

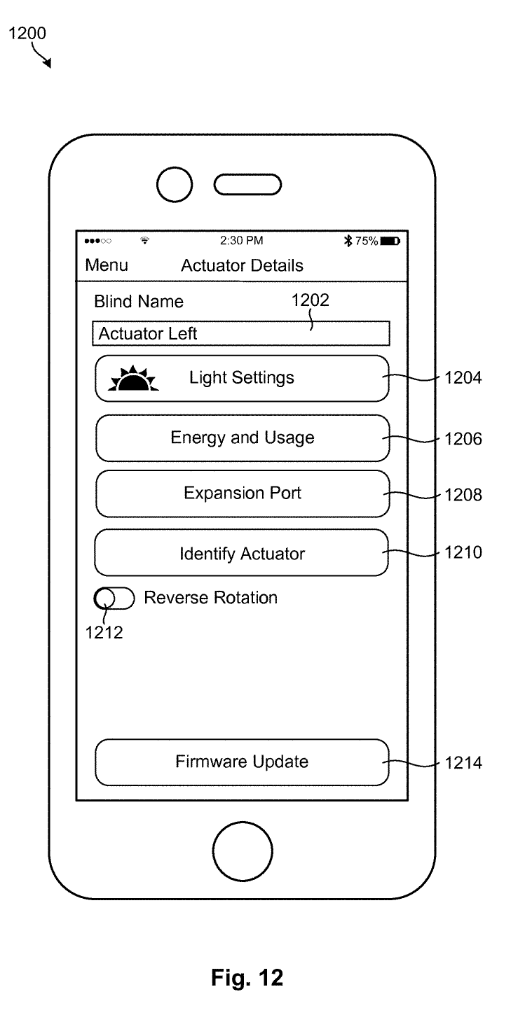

Referring to FIG. 12, one embodiment of a page 1200 for establishing various details for an actuation device 100 is illustrated. As shown, the page 1200 includes a field 1202 for designating or changing a name of an actuation device 100. In certain embodiments, descriptive names may be chosen to assist a user in differentiating actuation devices 100 from one another. A button 1204 may be selected to configure an actuation device 100 to operate in accordance with sensed lighting conditions, such as by opening in response to sunrise and closing in response to sunset. One embodiment of a page for configuring an actuation device 100 in this manner will be discussed in association with FIG. 13.

A button 1206 may be configured to display information regarding energy and usage associated with an actuation device 100. For example, selecting the button 1206 may enable a user to view a battery charge level, an estimated time that a battery charge will be depleted, usage patterns or particular instances of operation of the actuation device 100, or the like.

A button 1208 may enable a user to configure expansion ports or devices connected to expansion ports of the actuation device 100. For example, in certain embodiments, sensors such as temperature sensors, security sensors, or the like, may be connected to various expansions ports of an actuation device 100 to allow the actuation device 100 to provide additional features and functions. The button 1208 may present a screen or page that allows these expansion ports or devices to be configured.

An identify actuator button 1210 may assist a user in identifying the actuation device 100 identified in the field 1202. For example, selecting the button 1210 may cause the actuation device 100 to physically move or perform some other function to allow the user to determine which physical actuation device 100 corresponds to the actuation device 100 identified in the application. This may be helpful in situations where a room, home, or business contains multiple actuation devices 100 and the user is unsure which physical actuation device 100 corresponds to the names listed in the application.

A reverse rotation button 1212 may enable functions of a motorized gearbox to be reversed. For example, if a motorized gearbox assembly is installed in an actuation device 100 in the wrong (or opposite) direction, the application may allow functions of the actuator to be reversed instead of requiring removal of the actuation device 100 and reinstallation of the actuator in the opposite direction. Thus, the “reverse rotation” button 1212 may in certain cases save significant amounts of time and make installation of the motorized gearbox substantially fool-proof.

A firmware update button 1214 may enable a user to update firmware on the motorized gearbox assembly 102. One benefit of the invention compared to conventional actuator automation systems is the smart technology built into the device. Instead of simply receiving and executing commands, the actuation device may have processing capability that allows it to provide additional functionality. For example, in certain embodiments, the actuation device 100 may interface with security sensors for use in a security system, or temperature or humidity sensors for use in a climate-control or HVAC system. The firmware update button 1214 may enable updated firmware to be loaded (e.g., wirelessly loaded) onto the actuation device 100 to either improve existing functionality or expand the functionality of the actuation device 100.

Referring to FIG. 13, one embodiment of a page 1300 for establishing light settings for an actuation device 100 or a group of actuation devices 100 is illustrated. Such a page 1300 may be displayed in response to selecting the button 906 discussed in association with FIG. 29 or selecting the button 1204 discussed in association with FIG. 12. The page 1300 may enable an actuation device 100 or a group of actuation device 100 to be configured to operate in accordance with sensed lighting conditions. When working with a group of actuation devices 100, the group may, in certain embodiments, be configured to operate from a single light sensor (possibly a light sensor in single actuator or an external light sensor) in order to substantially synchronize the actuation devices 100. In other embodiments, each actuation device 100 in the group may operate in accordance with sensed lighting conditions from its own light sensor.

As shown in FIG. 13, in certain embodiments, the page 1300 may include a button 1302 to configure an actuation device 100 or group of actuation device 100 to automatically open at sunrise. In certain embodiments, a slider button 1306 may be provided to set the actuation device 100 position at sunrise. This may allow the actuation device 100 or group of actuation devices 100 to be completely or partially opened at sunrise. An actuator graphic 1310 adjacent to the button 1306 may visually open or close in response to movement of the slider button 1306 to show a position of the actuation device 100 and/or group of actuation devices 100.

Similarly, a button 1304 may be provided to configure an actuation device 100 or group of actuation device 100 to automatically close at sunset. A slider button 1308 may, in certain embodiments, be provided to set a desired actuation device 100 position at sunset. This may allow the actuation device 100 or group of actuation devices 100 to be completely or partially closed at sunset. An actuator graphic 1312 adjacent to the button 1308 may visually open or close in response to movement of the slider button 1308 to show a position of the actuation device 100 and/or group of actuation devices 100.

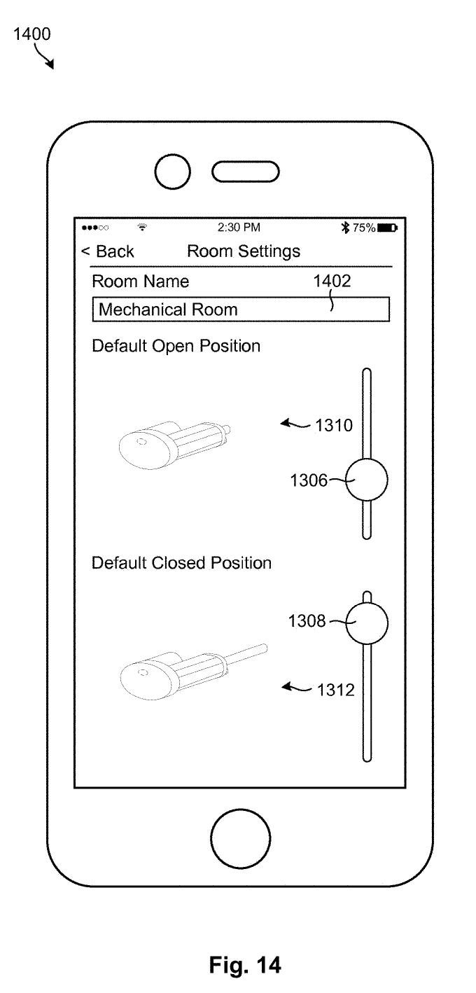

Referring to FIG. 14, one embodiment of a page 1400 for establishing settings associated with a room is illustrated. Such a page 1400 may be displayed, for example, in response to selecting the button 702 discussed in association with FIG. 7. The page 1400 may also, in certain embodiments, be displayed in response to selecting the add new room button 1704 discussed in association with FIG. 7. As shown, the page 1400 includes a field 1402 to create or edit a room name associated with a particular room or space. The page 1400 also allows default open and closed positions to be established for actuation device 100 associated with a room. In the illustrated example, slider buttons 1306, 1308 are provided to establish the default open and closed positions. Similarly, blind graphics 1310, 1312 may be provided to visually represent the default open and closed positions. When an open or close button 706, 708 is selected for a room, as previously discussed in association with FIG. 7, the actuation device 100 in the room may be opened or closed in accordance with the default positions.

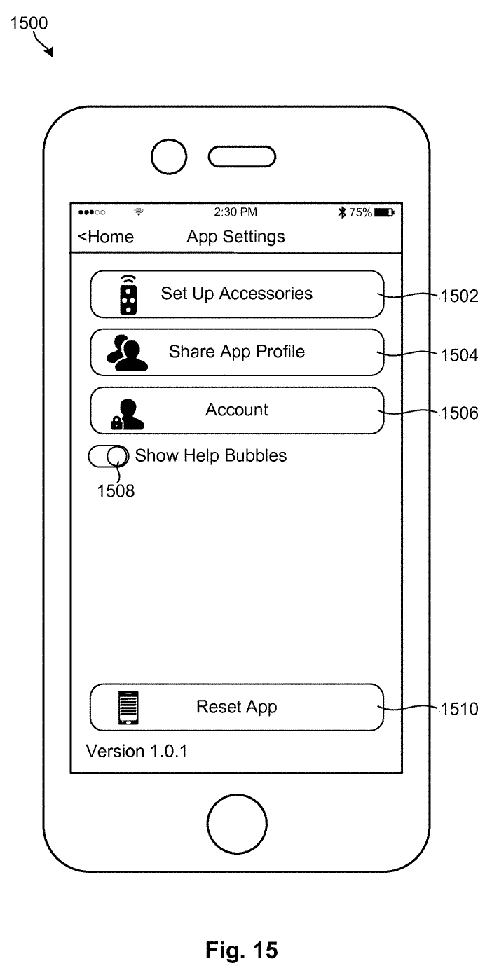

Referring to FIG. 15, one embodiment of an app settings page 1500 is illustrated. In the illustrated embodiment, the page 1500 includes a set up accessories button 1502, “share app profile” button 1504, “account button” 1506, “show help bubbles” 3508, and “reset app” button 1510. These buttons are provided by way of example and are not intended to be limiting.

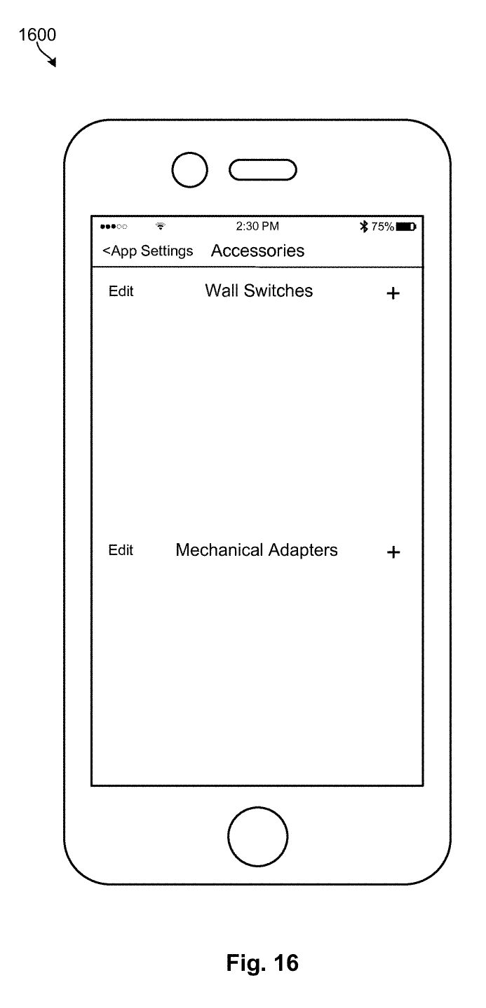

A “setup accessories” button 1502 may be provided to set up accessories related to an actuation device 100 or a group of actuation devices 100. Such accessories may include, for example, a wall switch configured to control actuation devices 100, a USB or HDMI dongle configured to control actuation devices 100, a temperature sensor connected to an actuation device 100, a security sensor connected to an actuation device 100, or the like. A page 1600 for setting up such accessories will be discussed in association with FIG. 16.

A “share app profile” button 1504 may enable settings established on a first device (e.g., smart phone, tablet, laptop, etc.) to be mirrored to a second device (e.g., smartphone, tablet, laptop, etc.). For example, if a large number of actuation devices 100 have been set up, named, and configured on a first device, the “share app profile” button 1504 may allow these settings to be mirrored to a second device without having to once again set up, name, and configure the actuation devices 100.

An account button 1506 may be used to establish a username, password, user preferences, and other account-related information associated with a user. In certain embodiments, a “show help bubbles” button 3508 may cause the application to display help information for screens, buttons, or other features or functionality in the application. These help bubbles may be displayed, for example, when a user touches, hovers over, or otherwise selects different screens, buttons, or features in the application. A reset app button 1510 may enable a user to reset the application. In certain embodiments, this may erase actuation device and other configuration information in the application, thereby allowing the user to start anew.

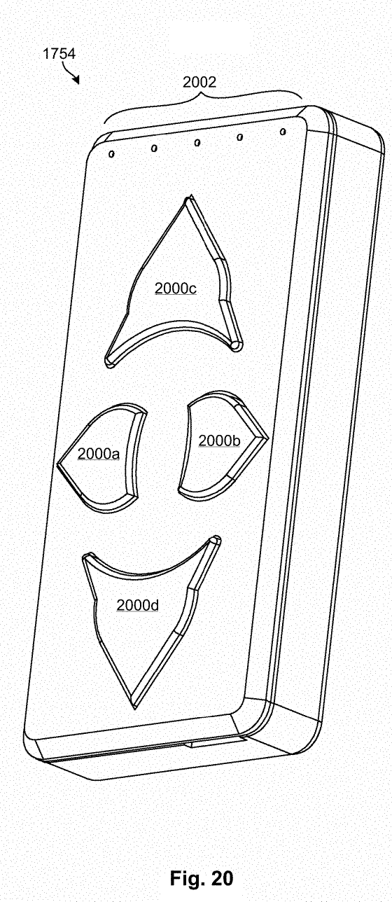

Referring to FIG. 16, one embodiment of a page 1600 for managing accessories related to an actuation device 100 or a group of actuation devices 100 is illustrated. In this example, the page 1600 shows a list of wall switches and TV adapters. In certain embodiments, an actuation device 100 or group of actuation devices 100 may be controlled (e.g., wirelessly controlled) by a wall switch, such as a specialized wall switch. One embodiment of such a specialized wall switch will be discussed in association with FIG. 20. Such a wall switch may, in certain cases, be used in place of or in addition to the manual controls provided by the application. As shown, the page 1600 may enable new wall switches to be added to the system as well as editing of existing wall switches.

Similarly, the page 1600 allows TV adapters to be added to the system or existing TV adapters to be edited. In certain embodiments, an actuation device 100 or a group of actuation devices 100 may be controlled by a video display adapter, such as a USB or HDMI dongle plugged into a USB or HMDI port of a video display. Such a video display adapter may be configured to generate a signal when a video display (e.g., a television, projector, etc.) is turned on or off. That is, the actuation device 100 or group of actuation devices 100 may automatically open or close in response to receiving the signal. This may allow a room or space to be automatically darkened when a television, projector, or other media device is turned on, and automatically lightened when the television, projector, or other media device is turned off. As shown, the page 1600 may enable new TV adapters to be added to the system as well as editing of existing TV adapters.

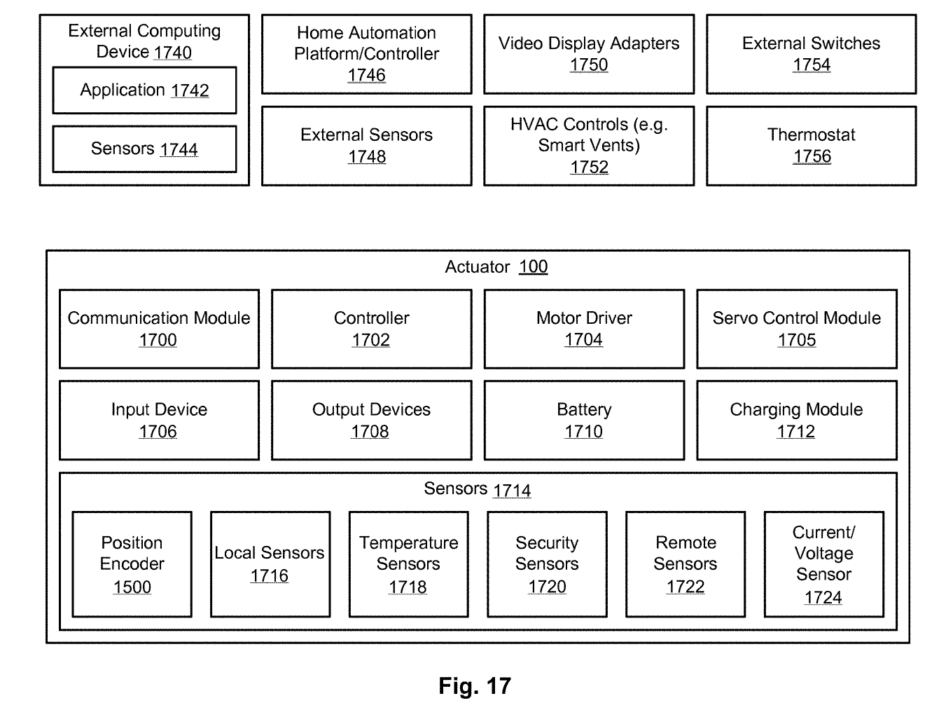

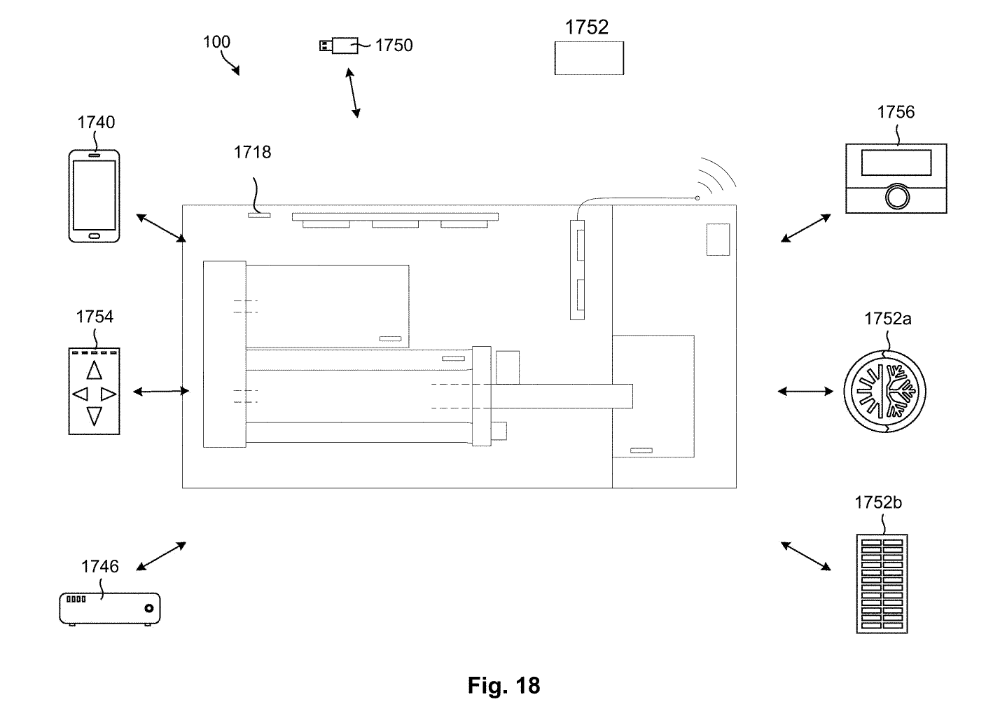

Referring to FIGS. 17 and 18, a high-level system view showing various components internal to and external to an actuation device 100 is illustrated. Various of the components (e.g., controller 1702, communication module 1700, motor driver 1704, etc.) shown inside the actuation device 100 may be implemented within the motorized gearbox assembly 102, such as on the circuit board 404 or within the housing 202 of the motorized gearbox assembly 102, although this is not necessary in all embodiments. Other components (e.g., battery 1710) may be implemented within the actuation device 100. Yet other components (local sensors 1716, temperature sensors 1718, security sensors 1720, solar cell 1712 etc.) may be implemented outside of the actuation device 100. For example, a temperature sensor 1718 or security sensor 372 may be mounted to a window and connected to the controller 1702 (using, for example, wires routed through a headrail. Nevertheless, the location and placement of the components illustrated in FIG. 17 may vary in different embodiments and is not intended to be limiting.

As shown, an actuation device 100 in accordance with the invention may include one or more of the following: a communication module 1700, controller 1702, motor driver 1704, servo control module 1705, input device(s) 1706, output device(s) 1708, battery 1710, and charging module 1712. The actuation device 100 may also include one or more sensors 3714, such as a position encoder 1500, light sensor 1716, temperature sensor 1718, security sensor 1720, safety sensor 1722, and current/voltage sensor 1724. The manner in which the various components of the actuation device 100 are used will be discussed in more detail hereafter.

A communication module 1700 may enable wireless communication between the actuation device 100 and external devices. In one embodiment, the communication module 1700 includes a Bluetooth chip that allows the actuation device 100 to communicate with a mobile device 130, remote switch 1754, video display adapter 1750, home automation controller 1746, or the like, using Bluetooth signals. In other embodiments, the communication module 1700 enables communication using other communication protocols, such as WIFI, Z-Wave, Zigbee, or the like. In certain embodiments, a bridge may be used to enable translation and compatibility between different communication protocols.

The communication module 1700 may also, in certain embodiments, act as a repeater to repeat signals to other devices. This may allow the communication module 1700 (and associated actuation device 100) to form part of a mesh network of interconnected devices. In some cases, an actuation device 100 may originate signals that are used to control other devices. For example, a temperature sensor 1718 connected to an actuation device 100 may measure temperature at or near a window. The measured temperature may be transmitted to a thermostat 1756 or other device to make adjustments to an HVAC system. Additionally, or alternatively, commands may be sent directly to an HVAC system to make adjustments thereto. Thus, in certain embodiments, the communication module 1700 may originate signals that are used to control devices external to the actuation device 100.

A controller 1702 may be configured to control the actuation device 100 and perform other functions, such as gathering information at or near the actuation device 100, controlling devices external to the actuation device 100, receive and execute commands from devices external to the actuation device 100, and the like. As can be appreciated by those of skill in the art, the controller 1702 may be programmable and may include a processor and memory to store and execute program code. As was discussed in association with FIGS. 7 through 16, the controller 1702 may be programmed to operate an actuation device 100 in accordance with a designated schedule or in response to sensed lighting conditions. Once programmed, the controller 1702 may operate the actuation device 100 on its own without requiring commands from external devices. The controller 1702 may also be configured to receive commands (e.g., open or close commands) from an external device such as a smartphone and operate the actuation device 100 accordingly. Thus, presence of the controller 1702 may enable the automated actuation device 100 to independently operate on its own (without centralized control), or operate in response to commands from a centralized controller external to the actuation device 100.

Control signals generated by the controller 1702 may be sent to a motor driver 1704 in order to operate the motor 400 previously discussed. In certain embodiments, these control signals may be converted to modulated control signals using a suitable modulation technique (e.g., pulse-width modulation, or PWM). The modulated control signals may be sent to the motor driver 180 to operate the motor 54, which may in turn adjust the angular position of louvers or slats. In certain embodiments, a servo control module 1705 may provide feedback to the controller 1702 regarding the angular position of the slats (using the position encoder 1500) relative to a desired angular position so that the operation of the motor 400 can be adjusted accordingly. This may reduce error between a desired angular position and an actual angular position of the slats.

The actuation device 100 may also include various input devices 1706 and output devices 1708. Input devices 1706 may include, for example, various sensors 3714 for gathering data in and around the actuation device 100. An input device 1706 may also, in certain embodiments, include an audio sensor for receiving voice commands or other audible signals, such as voice commands to open or close an actuation device 100 or group of actuation devices 100. Other types of input devices 1706 are possible and within the scope of the invention. Input devices 1706 may be incorporated into an enclosure of the actuation device 100, a solar panel attached to the actuation device 100, or the like.

Output devices 1708 may include, for example, LEDs, alarms, speakers, or devices to provide feedback to a user. Such output devices 1708 may, for example, indicate when a battery level for an actuation device 100 is low; when motion has been detected by an actuation device 100 (in embodiments where a motion sensor 1724 is incorporated into the actuation device 100); when connectivity is enabled, disabled, or lost between the actuation device 100 and other devices; when the actuation device 100 has experienced an error or other fault condition; when the actuation device 100 has detected smoke, carbon monoxide, or other gases (in the event a smoke or gas detector 1722 is incorporated into the actuation device 100); when a security event is detected by the actuation device 100, or the like. Such output devices 1708 may, in certain embodiments, be incorporated into an enclosure of the actuation device 100, a solar panel attached to the actuation device 100, or the like.

The actuation device 100 may also include a battery 1710 to power the motorized gearbox assembly 102. In certain embodiments, the battery 1710 is housed within the enclosure of the actuation device 100, external to the motorized gearbox assembly 102. The battery 1710 may be rechargeable. Alternatively, or additionally, the battery 1710 is recharged by a solar panel attached to the actuation device 100. For example, a solar panel may be attached to the actuation device 100 and placed near a window. In other embodiments, solar panels may be incorporated into or attached to an exterior surface of the enclosure of the actuation device 100. In certain embodiments, a charging module 1712 may boost low voltage from a solar panel to a higher voltage needed to charge the battery 1710 and/or operate various components within the actuation device 100.

As shown, the actuation device 100 may include various types of sensors 3714. Some of these sensors 3714 may be related to operation of the actuation device 100. Other sensors 3714 may take advantage of the actuation device's special placement within a home or building. The proximity of actuation device 100 to windows and other openings make it possible for smart actuation device 100 to provide a wide variety of features and functions not normally associated with actuation devices 100.

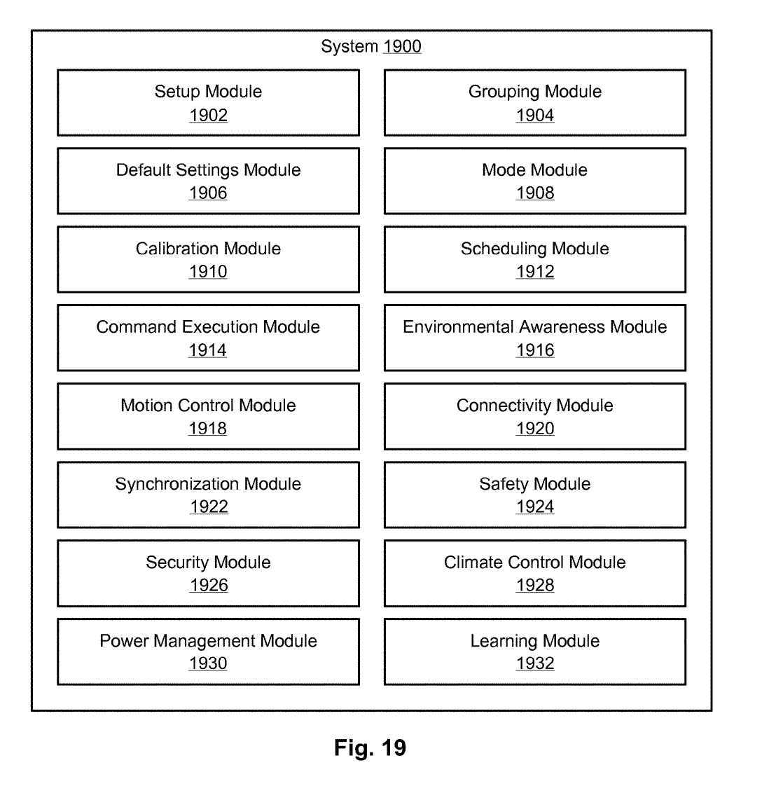

As previously mentioned, a position encoder 1500 may be used to track the number of rotations and/or angular position of the output shaft 200. The number of rotations and angular position of the output shaft 200 may be translated into an angular position of louvers or slats after the actuation device 100 has been calibrated. Various techniques for calibrating an actuation device 100 will be discussed in association with FIG. 19.

A light sensor 1716 may sense light levels at or around an actuator 100. Various types of local sensors 1716, including photovoltaic cells, cameras, photo diodes, proximity light sensor, or the like, may be used depending on the application. In certain embodiments, a light sensor 1716 may sense light external to a window. This may allow an actuation device 100 to open or close in response to lighting conditions outside a building. For example, an actuation device 100 may be configured to open at sunrise and close at sunset. Alternatively, or additionally, an actuation device 100 may be configured to open (either fully or partially) when conditions are overcast, thereby letting more light into a room or space, and close (either fully or partially) in response to detecting full sunlight, thereby letting less light into a room or space. In certain embodiments, a light sensor 1716 may be used to determine a total amount of light energy entering a room or space through a window. This information may be used to adjust an actuation device 100 or actuator 100, or adjust HVAC system parameters.

A light sensor 1716 may also be configured to sense light levels internal to a window, such as within a room or interior space. This may allow an actuation device 100 to be adjusted based on interior light levels. For example, an actuation device 100 may be opened in response to lower levels of interior light and closed in response to higher levels of interior light. In certain embodiments, various algorithms may be used to adjust actuation device 100 in response to both exterior and interior light levels, as opposed to just one or the other. Thus, in certain embodiments local sensors 1716 may be provided to sense both exterior and interior light levels.

In certain embodiments, the opening and closing of actuation device 100 may be coordinated with the turning on or off of lights in a room or space. For example, if lights in a room are turned off, actuation device 100 may be opened to compensate for the reduced amount of light. This allows natural light to replace artificial light and creates opportunities for conserving energy. In certain embodiments, lights may be automatically turned off and actuation device 100 may be automatically opened to replace artificial light with natural light when conditions allow. In such embodiments, the actuation device 100 and interior lighting may be controlled by a home automation platform or other controller to provide desired amounts of light in a room or space while simultaneously conserving energy.

A temperature sensor 1718 may be used to sense temperature at or around a window, room or area associated with the actuation device 100. In certain embodiments, the temperature sensor 1718 is configured to sense a temperature external to a window. For example, an infrared thermometer may be used to infer the temperature external to a window by detecting thermal radiation emitted from objects outside the window. In other embodiments, the temperature sensor 1718 is configured to sense a temperature internal to the window. In yet other embodiments, the temperature sensor 1718 is configured to sense a temperature of the window itself.

In certain embodiments, an actuation device 100 may be adjusted based on a temperature sensed by the temperature sensor 1718. For example, if an interior temperature of a room is deemed to be too low, the actuation device 100 may open a window covering to let in additional sunlight and warm the room. Similarly, if the interior temperature of the room is deemed to be too high, the actuation device 100 may close the window covering to reduce an amount of sunlight entering the room.

The actuation device 100 may also use the temperature sensor 1718 to anticipate changes in temperature. For example, if an exterior temperature or temperature of a window decreases (indicating it is getting colder outside), the actuation device 100 may be configured to open the blinds and warm a room in an effort to mitigate anticipated cooling of the room. Similarly, if an exterior temperature or temperature of a window increases (indicating it is getting warmer outside), the actuation device 100 may be configured to close the blinds in an effort to mitigate anticipated warming of the room.

In addition to adjusting the actuation device 100 itself, temperature measured at or near the actuation device 100 may be used adjust an HVAC system. The instant inventors have found that measuring temperature at or near a window may be more effective than measuring temperature inside a room (as performed by most thermostats) since windows are located at the boundaries of a room. Temperature changes at these boundaries tend to lead temperature changes in other parts of the room at least partly because windows tend to provide lesser levels of insulation compared to walls and other parts of the room. Thus, temperature readings gathered by an actuation device 100 in accordance with the invention may be used as part of a climate control system to adjust various HVAC system parameters. In certain embodiments, an actuation device 100 in accordance with the invention may actually replace a traditional thermostat used in homes or other establishments. That is, an actuation device 100 in accordance with the invention may monitor temperature at or near a window and, in response, relay at least one of commands and information to an HVAC controller to regulate room temperature in accordance with the monitored temperature. This may, in certain embodiments, eliminate the need for a conventional thermostat, or improve the function of conventional thermostats by providing improved temperature readings from boundaries (e.g., windows) in a room.

When an actuation device 100 is placed at or near windows, the actuation device 100 in accordance with the invention may also advantageously include security sensors 1720 to monitor security at or near a window. In one embodiment, the security sensor 1720 is a proximity sensor configured to detect opening and/or closing of a window or door. In another embodiment, the security sensor 1720 is an impact sensor configured to detect impacts on and/or breakage of a window. For example, an accelerometer may act as an impact sensor to detect an extent of force on a window. Different alerts or notifications may be sent to a user or other entity depending on the extent of the impact. For example, touching a window may trigger a low priority alert or notification. Larger forces (causing a window to break, for example) may trigger higher priority alerts or notifications. In some embodiments, high priority alerts may be configured to trigger gathering of camera footage at or near a window.

In another embodiment, the security sensor 1720 is a camera configured to gather video or still shots at or around a window. In certain embodiments, an LED or other lighting may be provided for recording video or still shots in low lighting conditions. The video or still shots may be streamed wirelessly to a centralized security system or stored on the actuation device 100 for later retrieval. In other embodiments, the security sensor 1720 is a motion sensor configured to detect motion at or around a window. In yet other embodiments, the security sensor 1720 is an audio sensor configured to collect audio at or around a window. By incorporating security sensors 1720 into actuation devices 100, security may be monitored at each window. In certain embodiments, information from the security sensors 1720 is relayed to a centralized security system. In other embodiments, an actuation device 100 in accordance with the invention may be configured to act as a centralized security system by gathering information from security sensors 1720 located at various actuation devices 100. Such a centralized security system may, in certain embodiments, send notifications to a user, smart device, security company, law enforcement office, or the like, when breaches of security are detected.

Various security sensors 1720 may be configured to work together in certain embodiments. For example, a motion sensor 1720 may, upon sensing motion, trigger operation of a camera 1720, microphone 1720, or other data gathering sensor 1720. In other embodiments, a motion sensor 1720 may trigger illumination of an LED or other output device, thereby warning a potential intruder that he or she has been detected. This may provide a deterrent effect. In other embodiments, a motion sensor 1720 may trigger operation of an actuator 100. For example, if a motion sensor 1720 detects that an intruder is approaching a window, the motion sensor 1720 may trigger closing of the actuation device 100 to close the blinds in order to obstruct the view through the window. Thus, security sensors 1720 may, in certain embodiments, trigger automatic operation of an actuation device 100 or a group of actuation devices 100.

To further increase security, an actuation device 100 in accordance with the invention may be password protected to prevent unauthorized access or control. Multiple failed password attempts may instigate a lockout from the actuation device 100.

The sensors 3714 may also, in certain embodiments, include remote sensors 1722 such as smoke detectors, carbon monoxide sensors, or the like. Outfitting actuation device 100 with such sensors 1722 may provide a large number of sensors at prime locations throughout a home or business, while at the same time eliminating or reducing the need to equip a home or business with separate independent sensors. In certain embodiments, alerts or notifications may be sent to a user or first responder when smoke, carbon monoxide, or other critical substances or gases have been detected.

A current/voltage sensor 1724 may be provided to sense current or voltage associated with the motor 400. In certain embodiments, this information may be used to ensure that the motor 400 is not overloaded. The current/voltage may also be used to calibrate the actuation device 100. For example, when the slats or louvers of an actuation device 100 are fully tilted (i.e., have reached their maximum angular position), the current of the motor 400 may spike in response to their non-movement. This spike in current may indicate that a maximum angular position has been reached. The angular position of the louvers or slats may be recorded at this point (using the position encoder 1500) to remember the maximum angular position. The louvers or slats may then be tilted in the opposite direction until they stop (i.e., reach their minimum angular position). The current of the motor 400 may again spike in response to the non-movement of the slats. This spike may indicate that a minimum angular position has been reached. The minimum angular position may be recorded. In this way, the current/voltage sensor 1724 may be used in conjunction with the position encoder 1500 to learn the angular range of motion and stopping points of the actuation device. In certain embodiments, this calibration technique may be performed when the actuation device 100 is initially powered up or installed. As will be explained in more detail hereafter, the current/voltage sensor 1724 may, along with the position encoder 1500, be used to estimate a size of an actuation device 100.

As further shown in FIG. 17, an actuation device 100 may, in certain embodiments, interface with devices external to the actuation device 100. For example, the actuation device 100 may communicate with a mobile device 130, such as a smart phone, tablet, laptop, desktop computer, or the like. The mobile device 130 may, in certain embodiments, execute an application 1742 for setting up, managing, and controlling the automated actuation device 100. One example of such an application 1742 was discussed in association with FIGS. 7 through 16.

In certain embodiments, sensors 1744 embedded within the mobile device 130 may be used to configure the actuation device 100. For example, GPS and/or compass sensors 1744 embedded in a smart phone may be used to determine a position and orientation of a window associated with the actuation device 100. This position and orientation may, in turn, be used to determine a position of the sun over time relative the window. The actuation device 100 may then be programmed so that it opens and/or closes the window covering (i.e., the slats are tilted) in a way that takes into account the position of the sun over time relative to the position and orientation of the window. In other embodiments, the position and orientation may be used to determine which way a camera or other device incorporated into an actuation device 100 is facing.

An automated actuation device 100 in accordance with the invention may also, in certain embodiments, interface with a home automation platform/controller 1746. Although an automated actuation device 100 in accordance with the invention may be programmed to operate on its own, the actuation device 100 may also be configured to work with various home automation systems using their native protocols, or using a bridge that translates the native protocols into the actuation system's native protocol. For example, an automated actuation device 100 may be controlled by and communicate with a centralized home automation system or controller using Z-Wave, Zigbee, Insteon, or other home automation protocols.

An automated actuation device 100 in accordance with the invention may also be configured to interface with external sensors 1748. Although various sensors 3714 (as previously discussed) may be located in the actuation device 100 or in close proximity to the actuation device 100, other sensors 1748 may be located external to the actuation device 100 and, in some cases, be far removed from the actuation device 100. For example, a temperature sensor located in one part of a building may be used to trigger operation of actuation device 100 in other parts of the building. In other cases, readings from multiple sensors 1748 located throughout a building may be used to influence operation of an actuation device 100 or a group of actuation devices 100. In certain cases, data may be gathered from external sensors 1748 and wirelessly communicated to an actuation device 100 or group of actuation devices 100.

In certain embodiments, an automated actuation device 100 in accordance with the invention may interface with one or more video display adapters 1750 (e.g., TV adapters 1750). In certain embodiments, a video display adapter 1750 may be embodied as a USB or HDMI dongle plugged into a USB or HMDI port of a video display. The instant inventors have found that, with most video displays (e.g., televisions), a USB or HMDI port of the video display becomes live (i.e., energized) when the video display is turned on. This same USB or HMDI port goes dead when the video display is turned off. Using this knowledge, a video display adapter 1750 in accordance with the invention may be designed that generates a signal when the video display is turned on. This signal may cause an actuation device 100 or group of actuation device 100 to close when the video display is turned on (thereby darkening a room or space) and open when the video display is turned off (thereby lightening the room or space). Such a system may provide simple, inexpensive, automated actuator control for home theaters, entertainment rooms, or other spaces. In certain embodiments, a video display adapter 1750 such as that described above may also be used to control devices other than actuation device 100 such as lighting, fans, audio/visual equipment, switches, or the like.

Referring to FIG. 18, a high-level view representing the system of FIG. 17 is shown, particularly showing possible physical locations of various components described in association with FIG. 17. An automated actuation device 100 in accordance with the invention may also interface with various HVAC controls 1752. For example, as previously mentioned, in certain embodiments an actuation device in accordance with the invention may measure temperature at or near a window and relay this temperature to a thermostat 1756, which may in turn adjust various HVAC parameters. In other cases, the actuation device 100 may actually function as a thermostat by directly adjusting HVAC parameters. Thus, the actuation device 100 may, in certain embodiments, replace a conventional thermostat. In doing so, the actuation device 100 may rely on its own temperature sensor 1718 and/or temperature sensors from other actuation device 100 or devices in making determinations with regard to adjusting HVAC parameters.

Adjusting HVAC parameters may include, for example, switching heating or cooling devices 1752 on or off, regulating a flow of air or heat transfer fluid, or adjusting other features of an HVAC device. Adjusting HVAC parameters may also include automatically adjusting smart vents 1752b or smart windows 1752b that regulate air flow into a room or space. This may provide more targeted heating and/or cooling of a room or area, as opposed to adjusting the heating and/or cooling of an entire building. In certain cases, smart windows 1752b may be opened if favorable temperatures are detected external to a home or business, and these temperatures can bring an interior temperature closer to a desired interior temperature. This may conserve energy and reduce utilization of conventional heating and cooling systems.

As previously mentioned, an actuation device 100 or group of actuation device 100 in accordance with the invention may also be controlled (e.g., wirelessly controlled) by external switches 1754, such as a remote control or the specialized wall switch discussed in association with FIG. 20. These switches 1754 may provide additional mechanisms for controlling an actuation device 100 or group of actuation devices 100. In certain cases, a remote switch 1754 or remote control 1754 may provide a faster and more convenient way to control an actuation device 100 or group of actuation device 100 than an application 1742. In certain embodiments, an external switch 1754 in accordance with the invention may provide functionality to control devices other than actuation devices 100.

Referring to FIG. 19, various modules included in a system 1900 in accordance with the invention are illustrated. These modules may be embodied in hardware, software, firmware, or a combination thereof. The modules are illustrated to show functionality that may be provided by the disclosed system 1900 as opposed to the locations where such functionality is implemented. For example, the functionality of some modules may be implemented entirely or mostly in the actuation device 100 in accordance with the invention. Other functionality may be implemented in an application 1742 executing on an external computer device 130, such as a smart phone or tablet. Other functionality may be implemented in a home automation controller 1746. Yet other functionality may be distributed between one or more of a motorized gearbox assembly 102, mobile devices 130, home automation controller 1746, and other devices. Thus, the location where the modules are implemented may vary in different embodiments.

Once outfitted with an actuation device 100 in accordance with the invention, a setup module 1902 may allow an actuation device 100 to be set up. Setting up the actuation device 100 may include, for example, detecting the automated actuation device 100 (with an mobile device 130), pairing the automated actuation device 100 with the mobile device 130 (when using Bluetooth, for example), naming the automated actuation device 100, assigning the automated actuation device 100 to a room, space, or group of actuation devices 100, establishing default open and/or closed position for the actuation device 100, setting up a schedule or manner of operation for the actuation device 100, and the like. In certain embodiments, the setup module 1902 may use one or more of the other modules illustrated in FIG. 19 to perform these tasks.

A setup module 1902 may, in certain embodiments, enable automated actuation device 100 to be ordered for a room or space. For example, the setup module 1902 may enable a user to input measurements for actuation device 100 in a room or space. In certain embodiments, the setup module 1902 may also allow the user to assign names to the actuation device 100 according to their location in the room or space. These names may be printed on the actuation device 100 at a manufacturing plant so that the actuation device 100 arrive at the user s home or business pre-labeled. This will ideally help the user quickly identify where the actuation device 100 are to be installed.

A grouping module 1904 may enable multiple actuation device 100 to be set up and controlled as a group. In certain embodiments, this may be accomplished by configuring one actuation device 100 in the group to act as a master and the other actuation device 100 in the group to act as slaves of the master. The group of actuation device 100 may, in certain embodiments, be configured to operate from a single schedule or sensors on a single actuation device 100, mobile device 130, or home automation controller 1746, thereby ensuring the actuation device 100 in the group are synchronized. In such an embodiment, the group of actuation device 100 may operate in response to a command or commands from the master actuation device 100, mobile device 130, or home automation controller 1746. In certain embodiments, separate commands are sent to each actuation device 100 belonging to a group to cause them to act in a synchronized manner. In other embodiments, a single command that is addressed to multiple actuation devices 100 is sent. Each actuation device 100 may receive the command and either execute or discard the command based on whether the command is addressed to the actuation device 100.

In other embodiments, the group of actuation device 100 may each operate from an identical schedule programmed into each actuation device 100, or from individual sensors in each actuation device 100 that are configured in the same way. As previously mentioned, an application 1742 in accordance with the invention may, in certain embodiments, provide buttons or options that allow actuation device 100 to be grouped, as well as provide buttons or options that allow the actuation device 100 to be controlled or programmed as a group as opposed to individually. The grouping module 1904 may also allow groups to be modified, such as by renaming a group, adding actuation device 100 to a group, naming actuation device 100 within a group, removing actuation device 100 from a group, and the like.

A default settings module 1906 may allow various default settings to be established for an actuation device 100 or a group of actuation devices 100. For example, a default open and/or closed position may be established for an actuation device 100 or group of actuation devices 100. When, an actuation device 100 is opened, such as by selecting an open button in an application 1742 or other device, the actuation device 100 may stop at the default open position. Similarly, when an actuation device 100 is closed, such as by selecting a close button in the application 1742 or other device, the actuation device 100 may stop at the default closed position. Other default settings are possible and within the scope of the invention.

A mode module 1908 may enable a user to establish and select from various modes for an actuation device 100 or group of actuation devices 100. Such modes may change the behavior of an actuation device 100 or group of actuation devices 100. For example, a user may establish an “at home” mode and an “away” mode that causes the user's actuation device 100 to behave differently based on whether the user is at home or away from home. For example, the user's actuation device 100 may be configured to open or close at different times or in response to different conditions based on whether the user is at home or away. An “away” mode in particular may, in certain embodiments, be configured to make a home or business appear to be occupied, such as by moving actuation device 100 periodically. Other actuation device 100 may operate a window covering in order to keep the covering closed in order to prevent viewing of valuable items within the home or business. The user may manually set the mode or the mode may be set automatically in response to different conditions (e.g., detecting activity or inactivity in a home using a motion sensor, detecting the presence or absence of a smart device, tag, or other device carried by an occupant, for example).

A calibration module 1910 may be configured to calibrate an actuation device 100 in accordance with the invention. For example, when an actuation device 100 is initially installed, the actuation device 100 may tilt louvers or slats in both directions to determine the angular range of motion. That is the actuation device 100 may tilt the slats in a first direction until the slats reach a first stopping point, and then tilt the slats in the opposite direction until the slats reach a second stopping point. Because, the slats may not have a hard stop in either direction, in certain embodiments the slats are tilted until the current of the motor 110 reaches a specified threshold (or until the position encoder 1500 detects that movement has substantially stopped) and then tilted in the opposite direction until the current of the motor 400 reaches the specified threshold (or until the position encoder 1500 detects that movement has substantially stopped). Alternatively, or additionally, the slats or louvers may be tilted until the angular velocity of the slats falls below a specified threshold and then tilted in the opposite direction until the angular velocity of the slats falls below the specified threshold. In this way, the calibration module 1910 may determine the limits of angular travel. Once these limits are determined using the position encoder 1500, the slats may be tilted to any intermediate angle between the limits using a simple calculation, and/or the actuation device 100 may be able to determine a current angular position of the slats.

In certain embodiments, the calibration module 1910 may also be configured to determine a size of the actuation device 100, such as the actuation device's length, width, overall area, or weight. This may be important to properly calibrate the actuation device 100 and ensure that a various mechanism associated with the actuation device 100 are not over-torqued. For example, a larger actuation device 100 may require more force to operate the actuation device 100 and a smaller actuation device 100 may require less force to operate the actuation device 100, due to the weight of their respective structure. Calculating the size of the actuation device 100 may ensure that a proper amount of power (and thus force) is applied to the associated mechanisms. In certain embodiments, the calibration module 1910 may calculate the weight by examining an amount of current drawn by the motor 400 (as measured by the current sensor 1724) in relation to an amount angular movement or speed of the motor 110 (as measured by the position encoder 1500). The more current that is drawn for a given angular distance or speed, the larger the size of the actuation device 100.

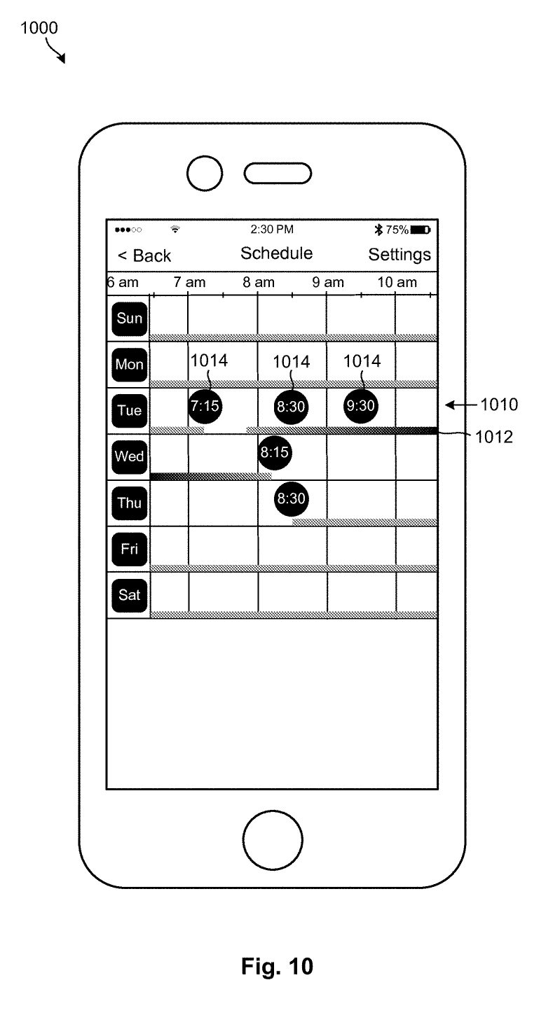

A scheduling module 1912 may be configured to schedule operation of an actuation device 100 or group of actuation devices 100. Various different techniques may be used to schedule operation of an actuator 100. In certain embodiments, a user may designate open/close times as discussed in association with FIG. 10. In other cases, a schedule may be automatically determined based on a time of year and/or location or orientation of an actuator 100. For example, a user may schedule an actuation device 100 to open at sunrise and close at sunset. The scheduling module 1912 may reference a database or utilize an algorithm to determine sunrise and sunset times for the actuation device 100 based on the actuation device's location and the time of year and schedule opening and closing time accordingly. These opening and closing times may be adjusted throughout the year as the position of the sun changes.

In other cases, the scheduling module 1912 may consider the orientation of an actuator 100. Based on the actuation device's orientation and the incidence of the sun on the actuation device 100 at different times of day, the opening and closing times may be adjusted. The opening and closing times of blinds may be adjusted based on the changing incidence of the sun on the actuation device 100 over time. In certain embodiments, each actuation device 100 may keep track of a current date and time using an internal clock or by referencing an external clock so that the position of the sun for the date and time can be determined.

A command execution module 1914 may enable an actuation device 100 to respond to commands in additional to following a schedule or operating in response to sensed lighting conditions. For example, a user may wish to manually open and close an actuation device 100 or a group of actuation device 100 by selecting buttons or options in an application 1742, or using a specialized wall switch 1754. For example, an actuation device 100 or a group of actuation device 100 may open in response to receiving an open command and close in response to receiving a close command. A stop command may cause the actuation device 100 or group of actuation device 100 to stop at their current angular position. Other commands are possible and within the scope of the invention.

An environmental awareness module 1916 may allow an actuation device 100 or group of actuation device 100 to operate in response to environmental conditions. For example, an actuation device 100 or group of actuation device 100 may be configured to open or close in response to changing lighting conditions, changing temperature conditions, detected motion, detected noise, detected security situations, detected safety situations, or the like. These conditions may be conditions inside a building, outside a building, or a combination thereof. The environmental awareness module 1916 may require sensors, placed at suitable locations, to detect environmental conditions that may trigger operation of the actuation devices 100.

A motion control module 1918 may be configured to control the motion of an actuator 100. As previously mentioned, functionality may be provided to designate how fast an actuation device 100 or group of actuation device 100 opens or closes in association with a particular event. As an example, a user may want an actuation device 100 or group of actuation device 100 to open or close over a specified period of time (e.g., 10 minutes, 30 minutes, an hour, etc.) instead of opening or closing in an abrupt manner. In other cases, the actuation device 100 may move gradually to mirror movement of the sun. In some cases, this may make movement of the actuation device 100 undetectable to the naked eye. The motion control module 1918 may enable this functionality. The motion control module 1918 may provide this functionality by performing slight incremental angular movements (possibly invisible to the eye) of the slats or louvers over a specified period of time. Alternatively, or additionally, the motion control module 1918 may simply adjust the speed of the motor 400. In certain embodiments, this may be accomplished using pulse-wide modulation (PWM) or other techniques to adjust the speed of the motor 400.

A connectivity module 1920 may be used to provide connectivity between an actuation device 100 and other devices. This may include providing connectivity between an actuation device 100 and a mobile device 130, a home automation platform/controller 1746, external sensors 1748, video display adapters 1750, HVAC controls 1752, external switches 1754, thermostats 1756, or other actuation devices 100. Any suitable communication protocol may be used. In certain embodiments, the connectivity module 1920 allows devices to act as repeaters of a signal, thereby allowing the devices to form a mesh network of interconnected devices.

A synchronization module 1922 may enable an actuation device 100 to be synchronized with an mobile device 130, such as a smart phone or tablet. For example, the synchronization module 1922 may enable an actuation device 100 to synchronize its date and time with the date and time of the mobile device 130. The synchronization module 1922 may also enable the actuation device 100 to synchronize itself with various sensors 1744 of the mobile device 130.

In certain embodiments, additional information, such as the size and dimensions (e.g., height, width) of the window 4400 may be input to the mobile device 130 by the user to further define the position and orientation of the window 4400. Once the position and orientation of a window 4400 are known, an actuation device 100 may be programmed to operate (e.g., open/close) based on the position and orientation of the window 4400 in relation to the position and orientation of the sun. The position and orientation of the window 4400 may also be used to determine how and when sunlight will be incident on a solar panel used to power an actuation device 100 or charge a battery 1710.

In certain embodiments, the operation of an actuation device 100 or group of actuation device 100 may be synchronized with a calendar, timer, or alarm clock of a mobile device 130. For example, an alarm clock associated with a mobile device 130 may cause an actuation device 100 or group of actuation device 100 to open and thereby allow sunlight to enter a room or space. Similarly, a calendar event or expiration of a timer may cause an actuation device 100 or group of actuation device 100 to open or close.

A safety module 1924 in accordance with the invention may be configured to provide various safety features at or near an actuator 100. For example, as previously explained, an actuation device 100 in accordance with the invention may be equipped with remote sensors 1722 such as smoke detectors, carbon monoxide sensors, or the like. In certain embodiments, the safety module 1924 may monitor these remote sensors 1722 and generate notifications or set off alarms when a hazardous or safety-related condition is detected.

A security module 1926 may be configured to monitor security at or near a window 4400 associated with an actuator 100. As previously mentioned, one or more security sensors 1720 may be incorporated into or located proximate a smart actuation device 100 in accordance with the invention. Using the security sensors 1720, the security module 1926 may detect events such as, opening or closing of a window, impacts on a window, breakage of a window, motion near a window, sound near a window, or the like. When a security related event or condition is detected, the security module 1926 may generate a notification, set off an alarm, or the like. In certain embodiments, the security module 1926 is configured to monitor security conditions at multiple windows, thereby providing comprehensive security throughout a home or business.

A climate control module 1928 may be configured to monitor and adjust the climate within a room or space. As previously mentioned, an actuation device 100 in accordance with the invention may be equipped with temperature sensors 1718, humidity sensors, or the like. These sensors may be used to monitor the climate internal to or external to a room or space. Using these sensors, the climate control module 1928 may monitor the climate and make adjustments where needed. In certain embodiments, the climate control module 1928 sends information to a thermostat 1756 so that the thermostat 1756 can adjust HVAC parameters (heating, cooling, humidity, air circulation, etc.) accordingly. In other embodiments, the climate control module 1928 adjusts the HVAC parameters directly.

A power management module 1930 may be configured to manage power required by an actuation device 100 in accordance with the invention. As previously mentioned, the actuation device 100 may be powered by a battery 1710. In certain embodiments, this battery 1710 is charged by a solar panel 1712. The solar panel 1712 may be accompanied by a charging module 1712 to boost a low voltage of the solar panel (in reduced lighting conditions) to a higher voltage needed to charge the battery and/or operate components of the motorized gearbox assembly 102. In other embodiments, the battery 1710 is charged through a pull cord 110.

In certain embodiments, the power management module 1930 may track power levels and/or usage trends of an actuation device 100 or group of actuation device 100 and make or suggest adjustments to more efficiently utilize power. For example, the power management module 1930 may adjust or suggest adjusting a number of scheduled openings/closings to extend battery life. In certain embodiments, the power management module 1930 may put an actuation device 100 (or selected components of an actuator 100) into a sleep or lower power mode when the actuation device 100 and/or any attached components (e.g., sensors) are not in use. Various events (detected motion, security events, safety-related events, etc.) may wake up an actuation device 100 or selected components of an actuator 100. An actuation device 100 may also wake up when communications are received from external devices, such as a mobile device 130, home automation controller 1746, video display adapter 1750, external switch 1754, other actuation devices 100, or the like. In some embodiments, the power management module 1930 may provide the usage trends of an actuation device 100 to another device (e.g., a hub and/or a cloud based server) for long term storage and complex analytics (for determining smart trends, anticipating needs based on other events, and the like).

A learning module 1932 may be configured to learn a user's tendencies and operate an actuation device 100 or group of actuation device 100 in accordance with those tendencies. For example, the learning module 1932 may observe that a user opens or closes an actuation device 100 at specific times of the day or in response to certain lighting conditions. This observation may take place continually or over a specified period of time. The learning module 1932 may then program the actuation device 100 or instruct the actuation device 100 to open or close at the observed times or in accordance with some algorithm designed to implement user preferences. In another example, the learning module 1932 may observe that the user opens or closes certain actuation device 100 at the same time or proximate in time and then program the actuation device 100 to open and close together as a group at the observed time. In yet other cases, the learning module 1932 may observe an angle that slats are adjusted to and adjust the slats accordingly. Other types of learning are possible and within the scope of the invention.

Referring to FIG. 20, one embodiment of a specialized wall switch 1754 in accordance with the invention is illustrated. The specialized wall switch 1754 may be battery powered or connected to a building's electrical system. The specialized wall switch 1754 enables large number of different devices (e.g., actuation device 100 or groups of actuation devices 100, lights, fans, heating systems, cooling systems, etc.) to be controlled (e.g., wirelessly controlled) with a single switch 1754, without requiring separate controls for each device or system. As shown the specialized wall switch 1754 includes a set of directional buttons 4000a-d for selecting a device or system to control, as well as adjusting an amount associated with the device or system. A first pair of directional buttons 4000a, 4000b enables a user to select a current function for the specialized wall switch 1754. A set of indicators 2002 (e.g., colored LEDs 2002, LEDs 2002 with accompanying pictures or icons, etc.) may be provided to indicate the current function of the specialized wall switch 1754. A second pair of directional buttons 4000c, 4000d enables the user to increase or decrease an amount associated with the current function. The first and second pairs of directional buttons 4000a-d may be oriented substantially perpendicular to one another. Similarly, the buttons 4000a-d may be embodied as separate buttons 4000a-d, as illustrated, or be embodied as one or more rocker or rocker-like switches, a directional pad, a control pad, a joystick, touchscreen with virtual directional buttons, or the like. For the purposes of the disclosure and claims, each of these embodiments will be collectively referred to as a directional switching device.

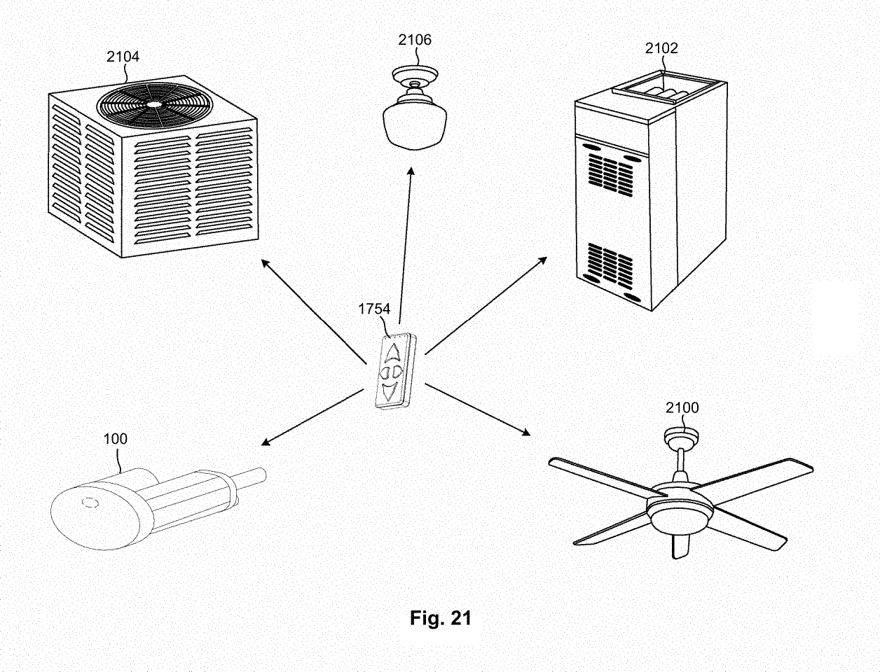

For example, referring to FIG. 21, while continuing to refer generally to FIG. 20, the illustrated specialized wall switch 1754 may be configured to control five different devices or systems, such as an actuation device 100 or group of actuation devices 100, a fan 2100, a heating system 2102 such as a furnace, a cooling system 2104, and lights 2106. These functions are presented by way of example and not limitation. Other types and numbers of functions are possible and within the scope of the invention.

A center indicator 2002 may be white and illuminate when lights 2106 are the current function. When lights 2106 are the current function, the buttons 4000c, 4000d may increase or decrease the intensity of the lights 2106, or turn the lights 2106 on or off. A first indicator 4002 right of center may be blue and illuminate when a cooling system 2104 is the current function. When the cooling system 2104 is the current function, the buttons 2000c, 2000d may turn a desired temperature up or down or, in other embodiments, turn the cooling system 2104 on or off. A first indicator 4002 left of center may be red and illuminate when a heating system 2102 is the current function. When the heating system 2102 is the current function, the buttons 2000c, 2000d may turn the desired temperature up or down or, in other embodiments, turn the heating system 2102 on or off.

A second indicator 4002 right of center may be green and illuminate when a ceiling fan 2100 (or other air circulation device 2100) is the current function. When the fan 2100 is the current function, the buttons 2000c, 2000d may adjust the speed of the fan 2100 up or down. A second indicator 4002 left of center may be yellow and illuminate when an actuation device 100 or group of actuation device 100 is the current function. When an actuation device 100 or group of actuation device 100 is the current function, the buttons 2000c, 2000d may adjust the tilt of the slats of the actuation device 100 or group of actuation device 100 or, alternatively, cause the actuation device 100 or group of actuation devices 100 to open or close.

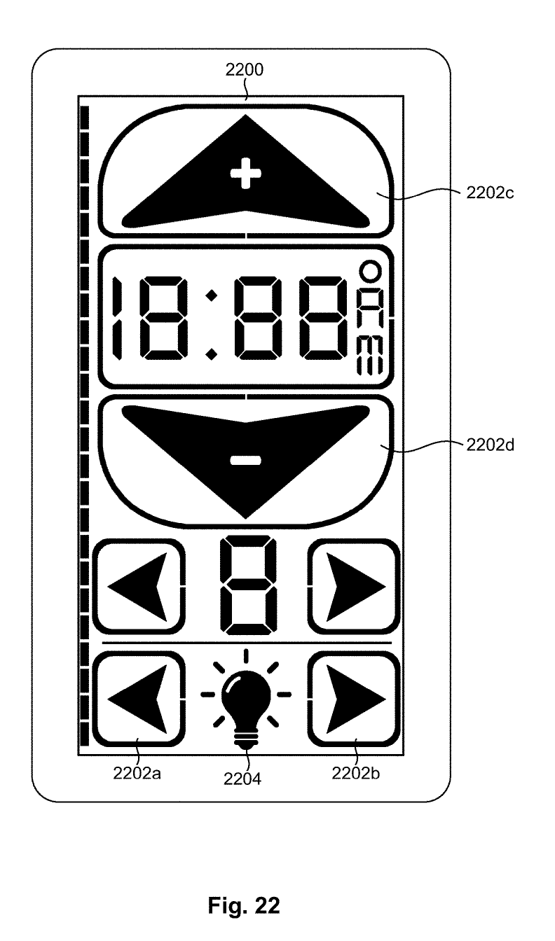

Referring to FIG. 22, in certain embodiments the specialized wall switch 1754 illustrated in FIG. 20 may be embodied as a touchscreen 2200 providing virtual directional controls similar to the physical controls shown of FIG. 20. As shown the touchscreen 2200 includes a set of virtual directional buttons 2202a-d for selecting a device or system to control, as well as adjusting an amount associated with the device or system. A first pair of virtual directional buttons 2202a, 2202b enables a user to select a current function for the touchscreen 2200. An indicator icon 2204 may be provided to indicate the current function of the touchscreen 2200. A second pair of virtual directional buttons 2202c, 2202d enables the user to increase or decrease an amount associated with the current function.

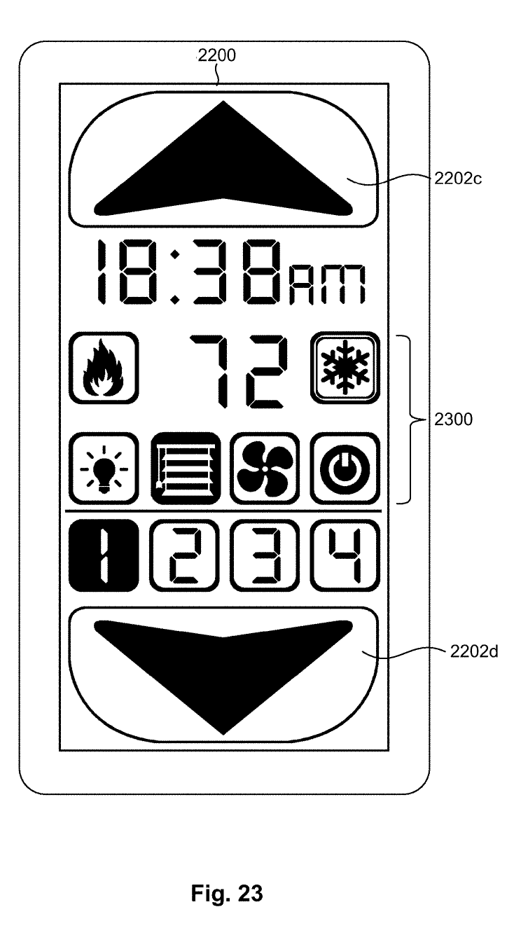

FIG. 23 shows an embodiment similar to that of FIG. 22 except that the virtual directional buttons 2202a, 2202b of FIG. 22 are replaced in FIG. 23 by virtual buttons 2300 or icons 2300 enabling a user to directly select a current function. In the embodiment shown in FIG. 23, the control buttons may be embodied as a touchscreen 2200 providing virtual directional controls similar to the physical controls shown of FIG. 20. The virtual button 2300 or icon 2300 representing the current function is bolded or has its colors inverted. Virtual directional buttons 2202c, 2202d enables the user to increase or decrease an amount associated with the current function.

Although particular reference has been made herein to actuation device 100 and types of actuation mechanisms, various features and functions of the disclosed embodiments of the invention may equally apply to other types of automated actuators and actuation mechanisms. The disclosed features and functions may also be applicable to other aspects of actuators 100.

The apparatus and methods disclosed herein may be embodied in other specific forms without departing from their spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An actuation device, comprising:
an actuator, wherein the actuator is a mechanical device;
a controller, wherein the controller controls the actuator;
a memory for storing data, the data comprising stored settings and calendar data, wherein the stored settings comprise factory preset data;
a performance sensor that provides performance data, wherein the performance sensor senses at least one of electrical performance and mechanical performance of the actuator; and
a processor configured to:
determine a first set of operating parameters associated with the actuator based on the performance data and at least one of the factory data and first remote data from a remote sensor;
determine a control command for operating the actuator based on the first set of operating parameters;
determine a second set of operating parameters associated with the actuator based on the performance data and at least one of the factory data and second remote data from the remote sensor;
determine that a difference between the second set of operating parameters and the first set of operating parameters exceeds a threshold;
modify the control command based on the determined difference; and
transmit the modified control command to the controller.

2. The actuation device of claim 1, wherein the processor is further configured to:
store the first set of operating parameters in the memory as baseline data;
store the control command in the memory;
store the second set of operating parameters in the memory; and
store the modified control command in the memory.

3. The actuation device of claim 1, wherein the processor is further configured to:
receive performance data from the performance sensor;
receive remote data from the remote sensor, wherein the remote sensor is included in a remote device that is located in a separate location than the actuation device.

4. The actuation device of claim 1, wherein the performance sensor provides performance data, wherein the performance sensor monitors a set of baseline performance parameters associated with the actuator during a first time period, and wherein the performance sensor monitors a set of real time performance parameters associated with the actuator during a second time period.

5. The actuation device of claim 4, wherein the processor is further configured to:
store the baseline performance parameters in the memory as performance base data;
store the real time performance parameters in the memory as real time data; and
determine that a performance difference between the baseline performance parameters and the real time data exceeds a threshold, wherein the determined difference comprises the performance difference.

6. The actuation device of claim 5, wherein the processor is further configured to:
identify an anomaly in the expected mechanical or electrical behavior of the actuator based on the determined performance difference.

7. The actuation device of claim 6, wherein the processor is further configured to:
transmit a trouble signal to another device; wherein the trouble signal comprises data describing one or more defining characteristics of the anomaly.

8. The actuation device of claim 6, wherein a modified control command compensates for the anomaly, wherein the modified control command causes the controller to send at least one modified signal to the actuator that causes the actuator to at least one of speed up, slow down, or stop in order to compensate for the anomaly.

9. The actuation device of claim 1, wherein the performance sensor comprises at least one of an electrical sensor; mechanical sensor; transducer; electromagnetic; electrochemical; electric current; electric potential; magnetic; radio; accelerometer; pressure; electro-acoustic; electro-optical; photoelectric; electrostatic; thermoelectric; radio-acoustic; electrical resistance; mechanical resistance; position resolver, optical encoder, capacitive encoder, Hall-effect device, incremental encoder, absolute encoder, absolute transducer of position, capacitive encoder, PIR, pyroelectric, magnetic field, vibration, motor speed, frequency, rotation, torque, ultrasonic, temperature, velocity; position; angle; displacement; or combinations thereof.

10. The actuation device of claim 1, further comprising:
a network device; wherein the network device communicates to a plurality of actuation devices within an actuation system.

11. The actuation device of claim 10, wherein the network device further comprises a wireless transmitter and wireless transceiver; wherein the network device has a connection to each network device of the one or more actuated devices; wherein the connection comprises a wired or wireless interface; and wherein the wireless interface comprises Bluetooth, WIFI, mesh network or similar wireless protocol.

12. The actuation device of claim 1, wherein the processor is further configured to:
receive user data from one or more user input devices; wherein the one or more user input devices comprises a user interface for receiving the user input from a user.

13. The actuation device of claim 12, wherein the one or more user input devices is a mobile device capable of wirelessly transmitting and receiving a signal; wherein the mobile device has a connection to the actuation device; wherein the mobile device comprises a cell phone, satellite phone, smartphone, personal digital assistant, tablet computer, laptop computer, remote control device, mobile transmitter, a mobile internet device or a combination of one or more of the same.

14. The actuation device of claim 1, wherein the performance sensor is at or adjacent to the actuator; wherein the performance sensor converts sensor data to an electrical signal; and wherein the performance sensors comprises at least one of: electromagnetic; electrochemical; electric current; electric potential; magnetic; radio; air flow; accelerometers; pressure; electro-acoustic; electro-optical; photoelectric; electrostatic; thermoelectric; radio-acoustic; environmental; moisture; humidity; fluid velocity; position; angle; displacement; or combinations thereof.

15. The actuation device of claim 1, wherein the remote data is transmitted from a remote system located in a separate part of a room, building, or outside of a building, wherein the remote system comprises at least one of a weather station, security system, wireless remote sensor device, fire alarm system, HVAC system, building control system, manufacturing control system, monitoring system; control system, or combinations thereof, wherein the remote sensors convert sensor data to an electrical signal, and wherein the remote sensors comprise at least one of: electromagnetic, electrochemical, electric current, electric potential, magnetic; radio, air flow, accelerometers, pressure, electro-acoustic, electro-optical, photoelectric; electrostatic, thermoelectric, radio-acoustic, environmental, moisture, humidity, fluid velocity, position, angle, displacement, or combinations thereof.

16. The actuation device of claim 1, wherein the processor is further configured to:
communicate with a cloud based network; wherein the processor is configured to mirror the stored settings and calendar data with the cloud based network by sending and receiving system data to and from the cloud-based network; wherein the system data comprises all data in the memory.

17. The actuation device of claim 16, wherein the remote data comprises weather data, and the remote data from the remote sensors and remote systems is relayed to the actuation device via the cloud-based network, and wherein the processor is further configured to:
determine a remote command based on at least one of the remote data, the stored settings, calendar data, and as directed by predefined user settings, or combinations thereof; and
transmit the remote command to the controller.

18. The actuation device of claim 1, wherein the actuator comprises one or more of electric motors, gearboxes and one or more mechanical means of incrementally opening, closing, tilting, turning, twisting, sliding, pushing, pulling, and rotating one or more components of the actuated device.

19. The actuation device of claim 1, further comprising:
one or more batteries; and
one or more solar photovoltaic panels.

20. The actuation device of claim 1, wherein the processor is further configured to:
monitor usage data of the actuator; and
provide the usage data to a disparate device.
